(19) United States
(12) Patent Application Publication
(10) Pub. No.: US 2003/0004800 A1
(43) Pub. Date: Jan. 2, 2003

(54) Method of and apparatus for distributing information, and computer product

(75) Inventor: Kouji Seino, Sendai (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 09/974,804

(22) Filed: Oct. 12, 2001

(30) Foreign Application Priority Data
Jun. 28, 2001 (JP) 2001-197069

(51) Int. Cl. G06F 17/60

(52) U.S. Cl. 705/14

(57) ABSTRACT

The method of distributing information according to the present invention includes the steps of transmitting the intensive information stored in a news source file to a predetermined user; preparing a reply mail related to the news information selected from the gathered plurality of news information; extracting predetermined news information based on the received replay mail, creating a homepage based on the extracted news information, and registering the homepage in a predetermined site; and extracting predetermined news information based on the received reply mail, preparing a detailed mail based on the extracted news information, and transmitting the mail.

### FIELD OF THE INVENTION

The present invention relates to a technology for providing information such as news via a network such as the Internet.

### BACKGROUND OF THE INVENTION

Recently, dissemination of information such as news or advertisement has been performed actively, using electronic mail (hereinafter, simply referred to as “mail”) or homepage through Internet. Also, transfer of mails via Internet and access to the homepage have recently performed not only by using personal computers, but also by using small portable terminal units such as mobile phones.

Conventionally, there exist services for providing information such as news to users as well as inserting advertising articles in the mail, by mailing list/mail distribution (so-called “mail magazine”) of the Internet. There also exist services for providing advertisement in line with user's intention, by distributing questionnaires beforehand to users to thereby grasp users' taste and preference based on the contents of the questionnaire.

However, in the provided information, information necessary to a user and information not necessary to the user exist together, making arrangement of necessary information complicated. As a result, there is a problem in that not only the memory capacity of an information terminal unit is suppressed by unarranged information, but also it is difficult to find necessary information quickly. In particular, with an increase of information content, much time and labor are required only for deleting unnecessary information.

Moreover, when the same information is transmitted to a personal computer and to a terminal unit having a small size such as mobile phone, there is a problem in that the information cannot be referred to efficiently.

Furthermore, there is a problem in that advertisement distributed together with the provided information may become hindrance at the time of referring to the information and arranging the information. An advertisement having no relation to the provided information is particularly a problem. Preliminary questionnaires heretofore performed in order to handle this problem have a problem in that it is complicated for users and cannot correspond to changes in taste and preference of users. Offer of confused advertisement has a problem in that it has less advertising effect also for the provider of the advertisement.

### SUMMARY OF THE INVENTION

It is an object of the present invention to provide a method of and an apparatus for distributing information and a computer program that make it possible for users to refer to, select and obtain information efficiently, and that can act for users in arrangement of the selected information. It is another object of the present invention to make it possible to provide effective advertisement to users.

The present invention according to one aspect is characterized by transmitting intensive information obtained by gathering all of or a part of the to-be-distributed information to a predetermined client unit, receiving selective information related to the to-be-distributed information selected from a plurality of to-be-distributed information gathered by the intensive information, extracting only predetermined to-be-distributed information from the to-be-distributed information database, based on the received selective information, creating contents by using the extracted to-be-distributed information and registering the created contents in a predetermined site.

Moreover, the present invention according to another aspect is characterized by transmitting intensive information obtained by gathering all of or a part of the to-be-distributed information to a predetermined client unit, receiving selective information related to the to-be-distributed information selected from a plurality of to-be-distributed information gathered by the intensive information, extracting only predetermined to-be-distributed information from the to-be-distributed information database, based on the received selective information, and transmitting the extracted to-be-distributed information to the predetermined client unit.

According to the present invention, a user only selects desired to-be-distributed information from the transmitted intensive information, to automatically create a homepage comprising only desired to-be-distributed information (and advertising information), or transmit a mail containing only desired to-be-distributed information (and advertising information).

Other objects and features of this invention will become apparent from the following description with reference to the accompanying drawings.

### BRIEF DESCRIPTION OF THE DRAWINGS

FIG. 1 is a diagram showing an outline of an embodiment of the present invention;

FIG. 2 is a diagram showing a construction of an advertising information file shown in FIG. 1;

FIG. 3 is a diagram showing a construction of a user information file shown in FIG. 1;

FIG. 4 is a diagram showing a construction of a news source file shown in FIG. 1;

FIG. 5 is a diagram showing a construction of a news category file shown in FIG. 1;

FIG. 6 is a diagram showing a construction of a news category file by user shown in FIG. 1;

FIG. 7 is a block diagram showing one example of a hardware configuration of an apparatus for distributing information (computer) according to this embodiment of the present invention;

FIG. 8 is a block diagram showing a functional construction of the apparatus for distributing information according to this embodiment of the present invention;

FIG. 9 is a flowchart showing the contents of processing in the transmission process shown in FIG. 1;

FIG. 10 is a diagram showing one example of a detailed mail to a PC, edited in the transmission process;

FIG. 11 is a diagram showing one example of a simple mail to a mobile phone, edited in the transmission process;

FIG. 12 is a flowchart showing the contents of processing in the reply process shown in a user's terminal unit (client unit);

FIG. 13 is a diagram showing one example of a method of preparing a reply mail in the reply process;

FIG. 14 is a diagram showing another example of a method of preparing a reply mail in the reply process;

FIG. 15 is a diagram showing the other example of a method of preparing a reply mail in the reply process;

FIG. 16 is a flowchart showing the contents of processing in the HP creation process shown in FIG. 1;

FIG. 17 is a diagram showing the contents of the HTML edit processing in the HP creation process;

FIG. 18 is a diagram showing one example of a display layout of a homepage created by the HP creation process;

FIG. 19 is a diagram showing another example of a display layout of a homepage created by the HP creation process;

FIG. 20 is a flowchart showing the other contents of processing in the HP creation process shown in FIG. 1;

FIG. 21 is a diagram showing the contents in the advertisement selection processing in the HP creation process;

FIG. 22 is a diagram showing another example of a display layout of a homepage created by the HP creation process;

FIG. 23 is a flowchart showing the contents of processing in the mail preparation process shown in FIG.

FIG. 24 is a diagram showing the contents in the text editing processing and advertisement selection processing in the mail preparation process;

FIG. 25 is a flowchart showing the contents in the keyword adding processing according to this embodiment of the present invention;

FIG. 26 is a flowchart showing the contents in the screen re-display processing according to this embodiment of the present invention;

FIG. 27 is a flowchart showing the contents in the update request processing according to this embodiment of the present invention;

FIG. 28 is a flowchart showing the contents in the update processing according to this embodiment of the present invention;

FIG. 29 is a flowchart showing the contents in the accounting information preparation processing according to this embodiment of the present invention; and

FIG. 30 is a diagram showing a system structure of a system for realizing the method of distributing information according to this embodiment of the present invention.

### DESCRIPTION OF THE PREFERRED EMBODIMENTS

Embodiment/s of the method of and the apparatus for distributing information and the computer program according to the present invention will now be described, with reference to the accompanying drawings.

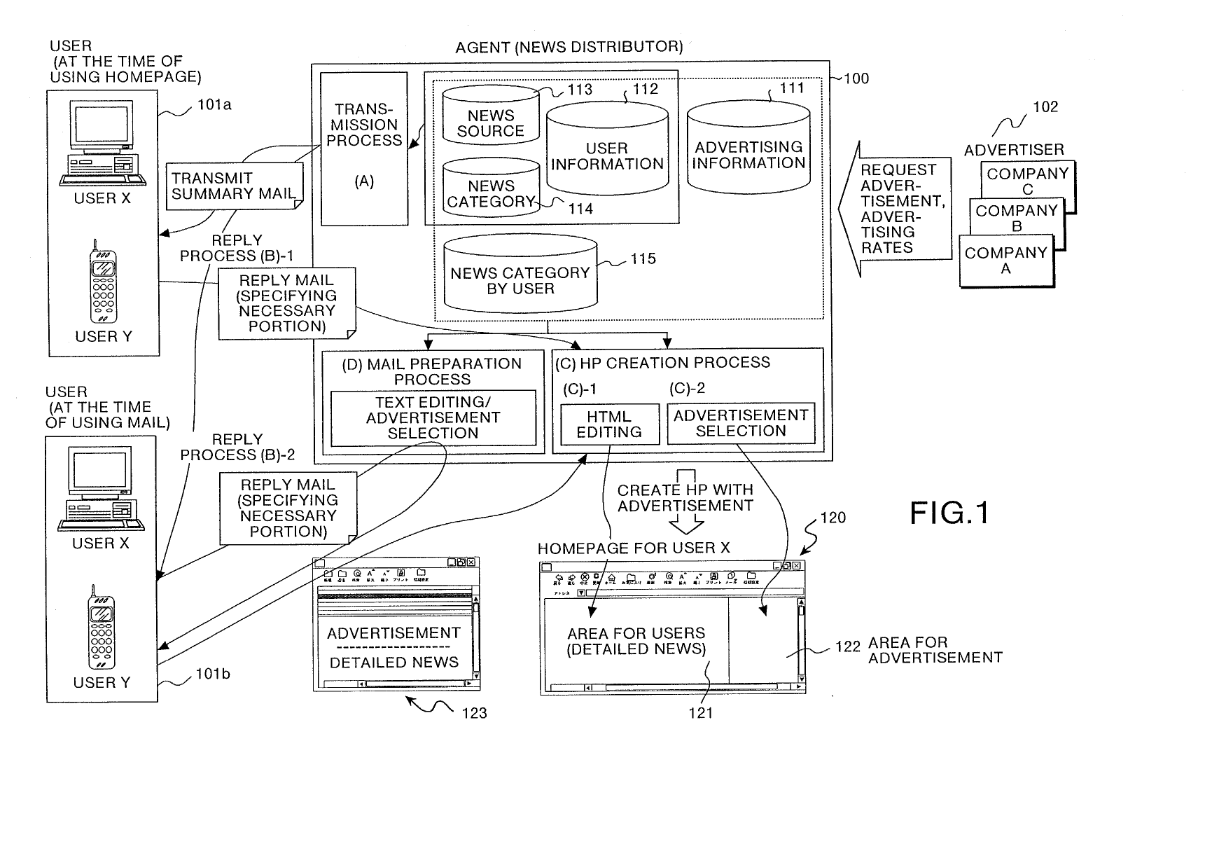

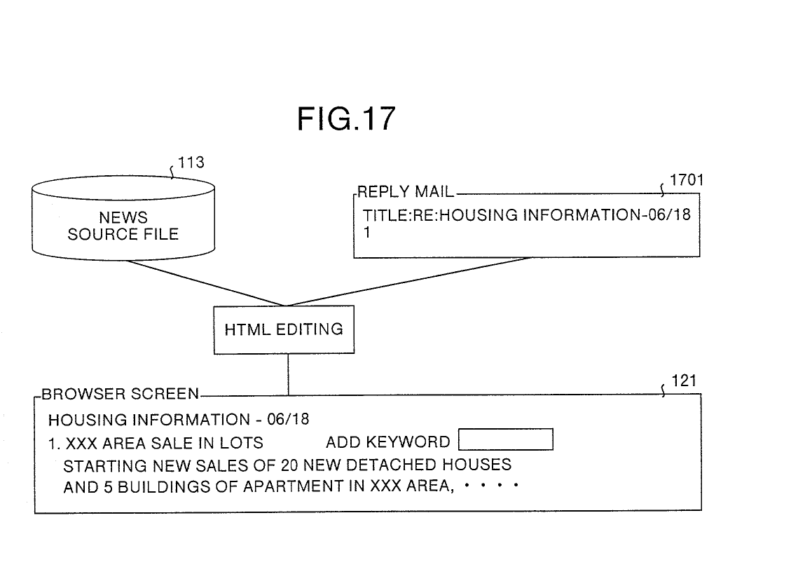

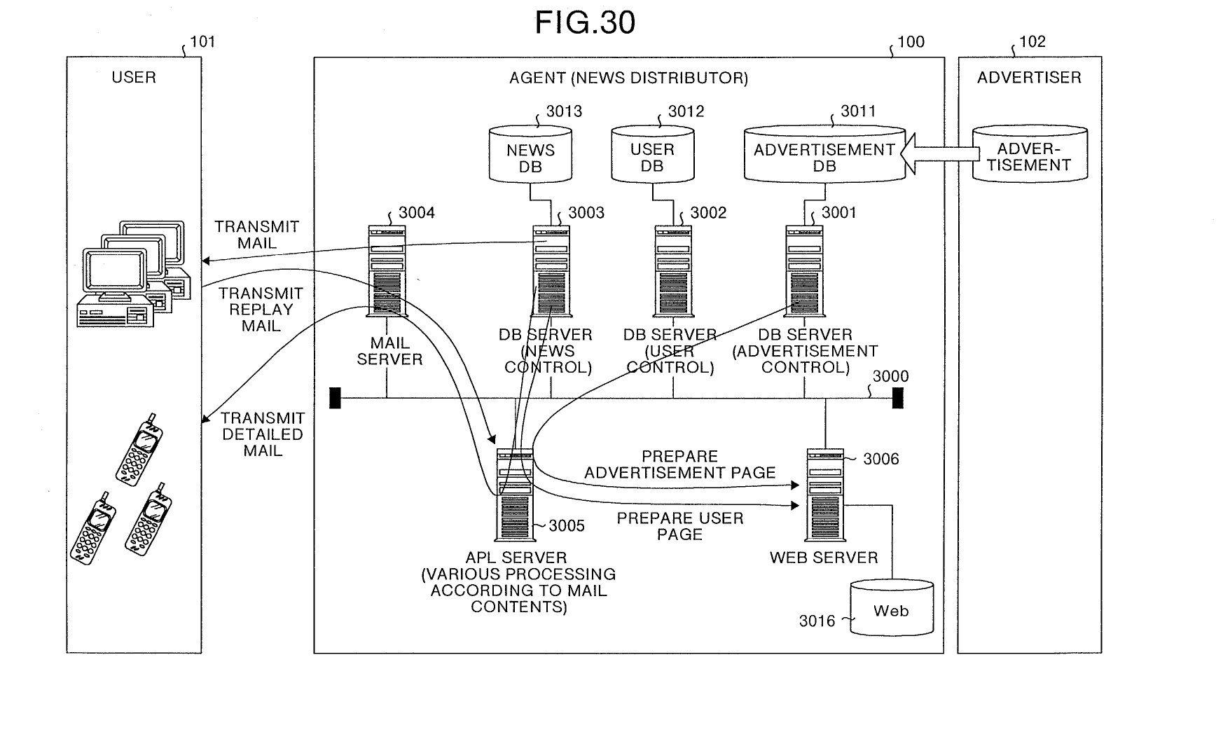

The summary of this embodiment of the present invention will be first described. FIG. 1 is a diagram showing an outline of this embodiment of the present invention. In FIG. 17 reference numeral 100 denotes an agent of distributed news (or a distributor of news). For example, it is an Internet provider or the like, and it is specifically constituted of hardware such as a server (details of the system structure will be described later (see FIG. 30)).

Reference numeral, 101 denote a user of the distributed news. Each user is constituted of hardware of an information processing unit having a communication function, such as a personal computer or a mobile phone, as a client unit, and connected to the server of the agent 100 via a network. 102 denote an advertiser who provides advertisement attached to the news distributed by the agent 100.

The agent 100 comprises various files such as an advertising information file 111, a user information file 112, a news source file 113, a news category file 114 and a news category file by user 115, and includes various processes such as a transmission process (A), a homepage (HP) creation process (C) and a mail preparation process (D).

In the transmission process (A), intensive information of the news information (news source) stored in the news source file 113 is transmitted to the user 101 as a summary mail. In the next reply step (B), a reply mail related to the selective information of the above news information (specifying necessary portion) is sent back to the agent 100. In the HP creation process (C), a homepage related to the news information is created based on the above selective information (and the advertising information) and registered in a predetermined site. Also, in the mail preparation process (D), a detailed mail of the news information is prepared based on the above selective information (and the advertising information), and transmitted to the user 101.

By performing such processing, the user 101 selects desired news information, by looking at only the summary mail. Then, only the selected news information, the detailed information thereof is created as a homepage, and hence only the desired news information can be read efficiently in the later stage (user 101a).

Moreover, the to-be-distributed information may be information having high urgency, which is desired to see immediately, without relying on the information processing terminal unit (media). Furthermore, there is a case where it is desired to judge whether it is necessary or not after having confirmed not only the selective information but also the detailed information, or there is a case where it is judged to be necessary after having confirmed the detailed information. In order to correspond to such needs, detailed information of the selected news information can be also received by mail (user 101b), so that only the desired news information can be read at once.

The user 101 also has an information processing terminal unit connected to the agent 100 via a network. As the information processing terminal unit (medium), there are generally a personal computer (user X) and a portable type information processing terminal unit (user Y) such as a mobile phone or a PDA. Also one user can make best use of a plurality of media.

For example, it is possible to perform arrangement of the to-be-distributed information with a medium having a small screen such as a mobile phone and capable of being carried at any time and any place, and to perform reference to the detailed contents of the to-be-distributed information with a large screen of the personal computer. In this manner, it becomes possible to utilize the media characteristics of the personal computer and the mobile phone, and perform arrangement of information without relying on the media.

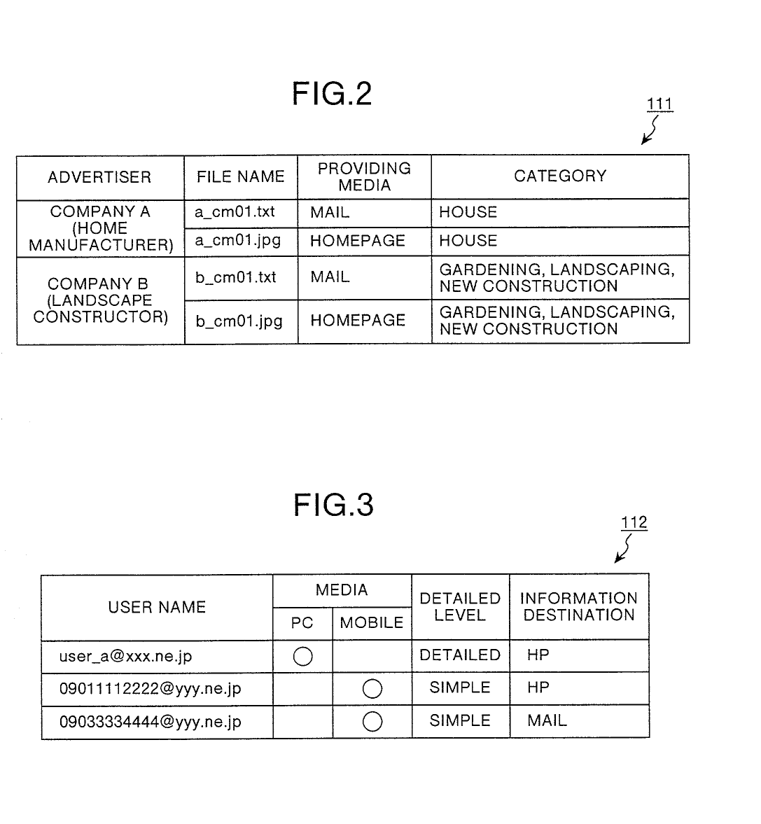

Contents (construction) of various files that the agent 100 has will now be described. FIG. 2 is a diagram showing the construction of the advertising information file 111 shown in FIG. 1. In FIG. 1, the advertising information file 111 stores advertising information, and includes an “advertiser” item related to the contents showing advertisers, a “file name” item related to file names, a “providing media” item related to media capable of providing advertisement, and a “category” item related to categories associated with the content of each advertisement.

In the above-described “filename” item, text document names, image file names and the like are stored. In the above-described “providing media” item, there are stored kinds, for example, providing by mail, providing by homepage, etc. Also, in the above-described “category” item, one or a plurality of categories associated with the contents of the advertisement may be stored.

FIG. 3 is a diagram showing a construction of the user information file 112 shown in FIG. 1. In FIG. 3, the user information file 112 stores information related to users, and includes a “user name” item related to user names (mail addresses) of this service, a “media” item related to the medium the user utilizes, a “detailed level” item related to the detailed level of the to-be-distributed information (news), and an “information destination” item related to the destination when the detailed information is to be provided.

In FIG. 3, there are written two kinds, “PC” and “mobile (phone) ” in the above “media” item, but the kinds are not limited to two kinds. The above “detailed level” is not limited to two kinds of “detailed” and “simple”. The detailed level may be categorized stepwise, such as “simple 1”, “simple 2”, . . . , or “detailed 1”, “detailed 2”. . . .

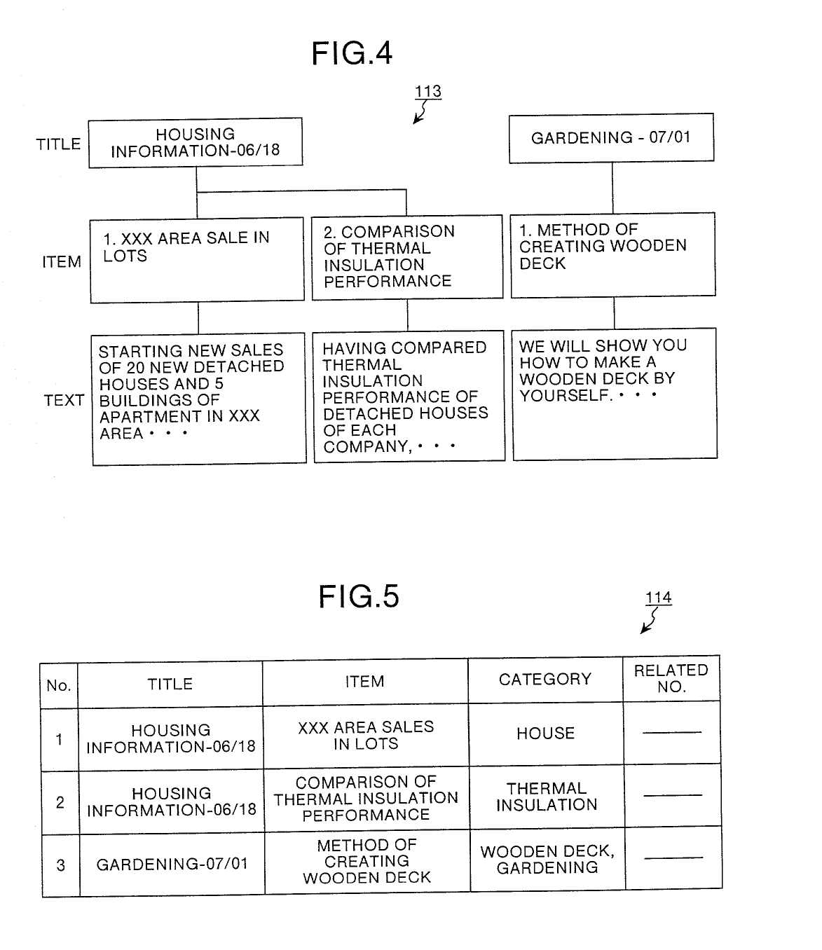

FIG. 4 is a diagram showing a construction of the news source file shown in FIG. 1. In FIG. 4, in the news source file 113, there are stored each news information constituted of three hierarchies: “title” related to the title of the news information; “item” related to headline or the like of the news information; and “text” which describes detailed contents of the news information. In FIG. 4, only three hierarchies are shown, but the hierarchy of respective news information may be three of more. For example, the contents of the text may be divided into simple contents and more detailed contents.

FIG. 5 is a diagram showing a construction of the news category file shown in FIG. 1. In FIG. 5, the news category file 114 stores information related to categories of each news information, and includes “No.” for identifying news information, “title” related to the title of the news information, “item” related to the headline of the news information, “category” for classifying news information, and “related No.” for associating at the time of updating the news information. Here, the above-described “category” is not limited to one and may include a plurality of categories registered therein.

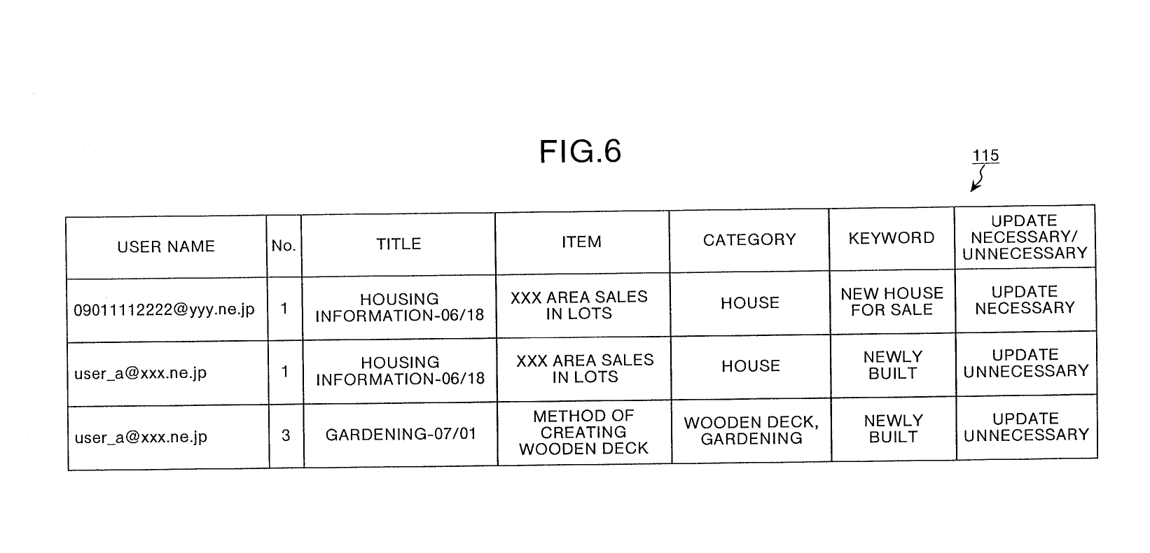

FIG. 6 is a diagram showing a construction of the news category file by user shown in FIG. 1. In FIG. 6, the news category file by user 115 stores information related to categories of each news information for each user, and includes each items of “user name”, “No. ”, “title”, “item”, “category”, “keyword”, and “update necessary/unnecessary”.

Here, in the “keyword” item, there is stored information related to keywords added for a user to arrange and classify news information. In the “update necessary/unnecessary” item, there is stored information related to whether to update also homepage, when the news information is updated. Detailed contents of the “keyword” item and the “update necessary/unnecessary” item will be described later.

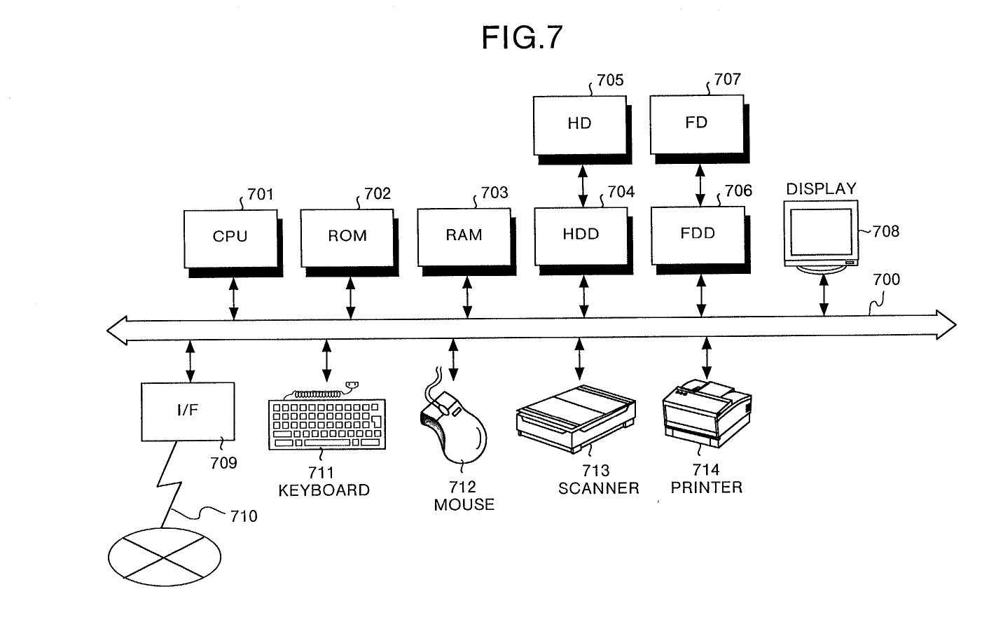

The hardware constitution of the apparatus for distributing information for realizing the contents in this embodiment of the present invention will now be described. FIG. 7 is a block diagram showing one example of a hardware configuration of the apparatus for distributing information (computer) according to this embodiment of the present invention.

This apparatus for distributing information comprises a CPU 701, a ROM 702, a RAM 703, an HDD (hardware disk drive) 704, an HD (hard disk) 705, an FDD (floppy disk drive) 706, an FD (floppy disk) 707 as one example of a detachable recording medium, a display 708, an I/F (interface) 709, a keyboard 711, a mouse 712, a scanner 713, and a printer 714. Each constituent is connected to each other by a bus 700.

The CPU 701 is in charge of control of the whole apparatus for distributing information. The ROM 702 stores programs such as a boot program. The RAM 703 is used as a work area of the CPU 701. The HDD 704 controls read/write of data with respect to the HD 705 in accordance with the control of the CPU 701. The HD 705 stores the written data under control of the HDD 704.

The FDD 706 controls read/write of data with respect to the FD 707 in accordance with the control of the CPU 701. The FD 707 stores the written data under control of the FDD 706, and the data stored in the FD 707 is read into the information processing unit. As a detachable recording medium, there may be used a CD-ROM (CD-R, CD-RW), MO, DVD (Digital Versatile Disk), memory card or the like, other than the FD 707. The display 708 displays not only icons or a tool box, but also a window (browser) related to data such as documents, images, functional information or the like. For example, CRT, TFT liquid-crystal display, plasma display or the like can be used.

The I/F (interface) 709 is connected to a network such as LAN or Internet through a communication line 710, and also connected to other information processing unit (server or the like) via the network. The I/F 709 is in charge of interface between the network and the inside, and controls input/output of data to/from other servers or information terminal units. The I/F 709 is, for example, a modem. When the apparatus for distributing information performs radio communication with a mobile phone or the like, the I/F 709 has a function also as a communication apparatus (radio transmitter).

The keyboard 711 has keys for input of characters, figures, and various instructions, and performs input of data. It may be a touch panel type input pad or the like. The mouse 712 works for moving the cursor, selecting an area, moving a window or changing the size thereof. So long as it has the same function as a pointing device, a track ball, a joystick or the like may be used.

The scanner 713 reads the image optically, and takes the image data into the information processing unit. The printer 714 prints out image data and document data. For example, a laser printer or an inkjet printer can be used.

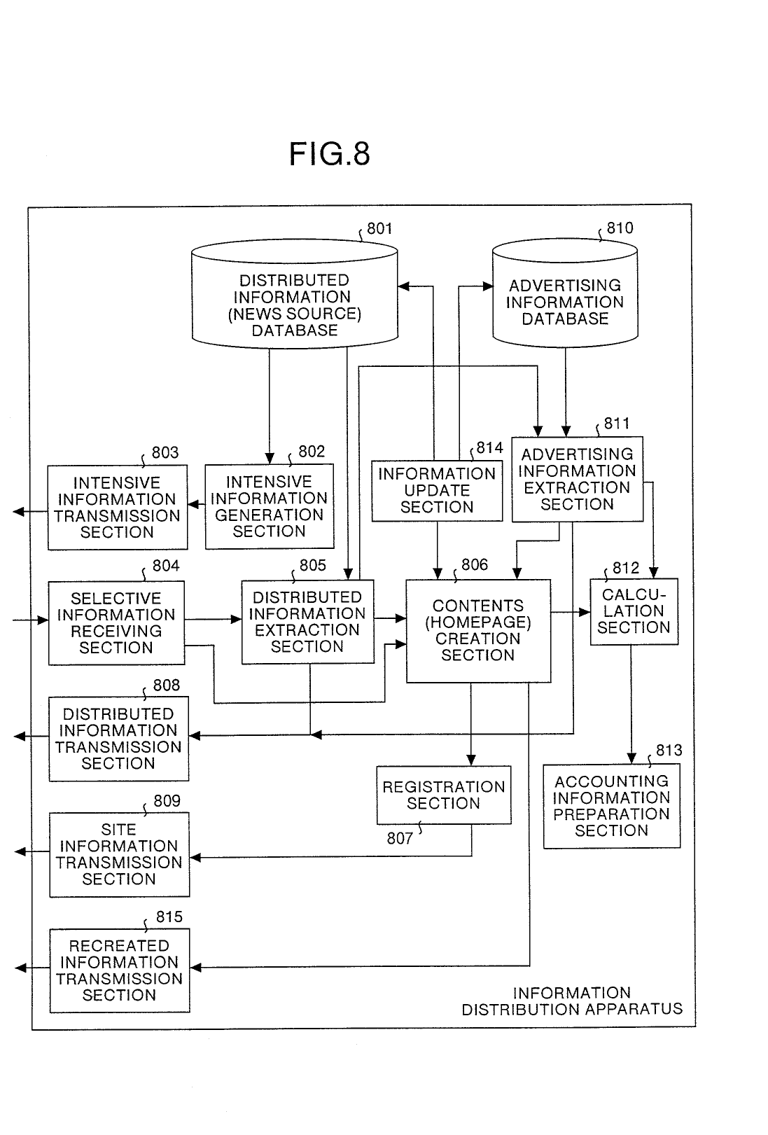

FIG. 8 is a block diagram showing a functional structure of the apparatus for distributing information according to this embodiment of the present invention. As shown in FIG. 8, the apparatus for distributing information has a construction including to-be-distributed information (news source) database 801, an intensive information generation section 802, an intensive information transmission section 803, a selective information receiving section 804, a to-be-distributed information extraction section 805, a contents (homepage) creation section 806, a registration section 807, a to-be-distributed information transmission section 808, a site information transmission section 809, advertising information database 810, an advertising information extraction section 811, a calculation section 812, an accounting information preparation section 813, an information update section 814, and a recreated information transmission section 815.

In the to-be-distributed information (news source) database 801, there is stored a plurality of to-be-distributed information (news source). This to-be-distributed information database 801 corresponds to the news source file 113 shown in FIG. 1. The to-be-distributed information database 801 realizes its function by, for example, RAM 703, HD 705, or FD 707 shown in FIG. 7.

The intensive information generation section 802 generates intensive information by gathering all of or a part of the to-be-distributed information stored in the to-be-distributed information database 801. Here, a part of the to-be-distributed information stands for a part of to-be-distributed information in the whole to-be-distributed information (news source) stored in the to-be-distributed information database 801. For example, the intensive information generation section 802 extracts a part of the to-be-distributed information from the whole to-be-distributed information stored in the to-be-distributed information database 801 (news source file 113), using the user information file 112, the news category file 114 and the news category file by user 115 shown in FIG. 1.

The above-described part of the to-be-distributed information also stands for a part of contents of the whole contents of respective to-be-distributed information. For example, the intensive information generation section 802 extracts information only in a predetermined hierarchy (information in the hierarchy of “title”, or information in the hierarchy of “title” and “item” shown in FIG. 4) of the hierarchized to-be-distributed information, to generate the extracted information as intensive information. Alternatively, the intensive information may be generated by extracting a specific sentence or words from the information in the whole of respective to-be-distributed information or in the above-described each hierarchy, instead of extracting by hierarchy. The intensive information generation section 802 realizes its function by the program stored in, for example, the ROM 702, the RAM 703, the HD 705, or the FD 707 shown in FIG. 7, which is executed by the CPU 701.

The intensive information transmission section 803 transmits the intensive information (summary mail) generated by the intensive information generation section 802 to a predetermined client unit. Specifically, the intensive information transmission section 803 specifies the destination using the user information file 112, and transmits the intensive information to that destination. The intensive information transmission section 803 realizes this function by the I/F 709 or the like shown in FIG. 7. Then, the transmission process (A) shown in FIG. 1 is realized by the intensive information generation section 802 and the intensive information transmission section 803.

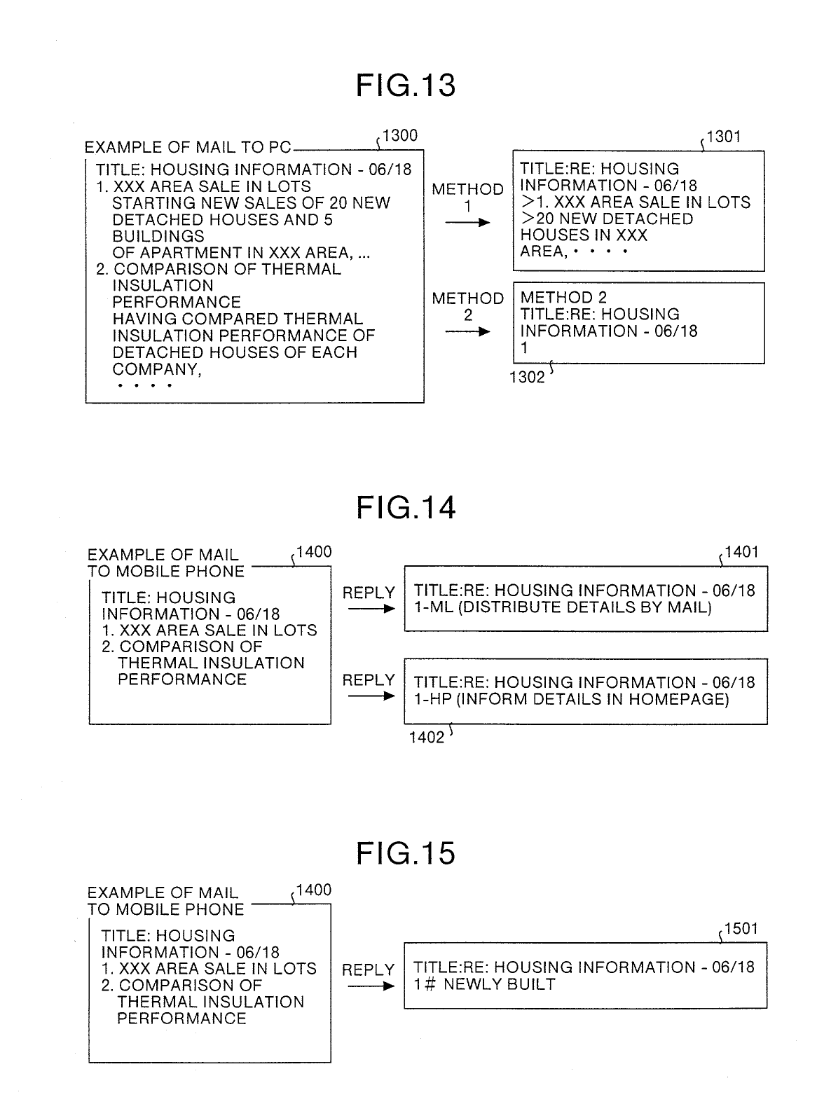

The selective information receiving section 804 receives selective information related to the to-be-distributed information selected from a plurality of to-be-distributed information gathered by the intensive information, from the predetermined client unit. The detailed contents of the above selective information will be described later (see FIG. 13 to FIG. 15). The selective information receiving section 804 realizes its function by the I/F 709 or the like shown in FIG. 7.

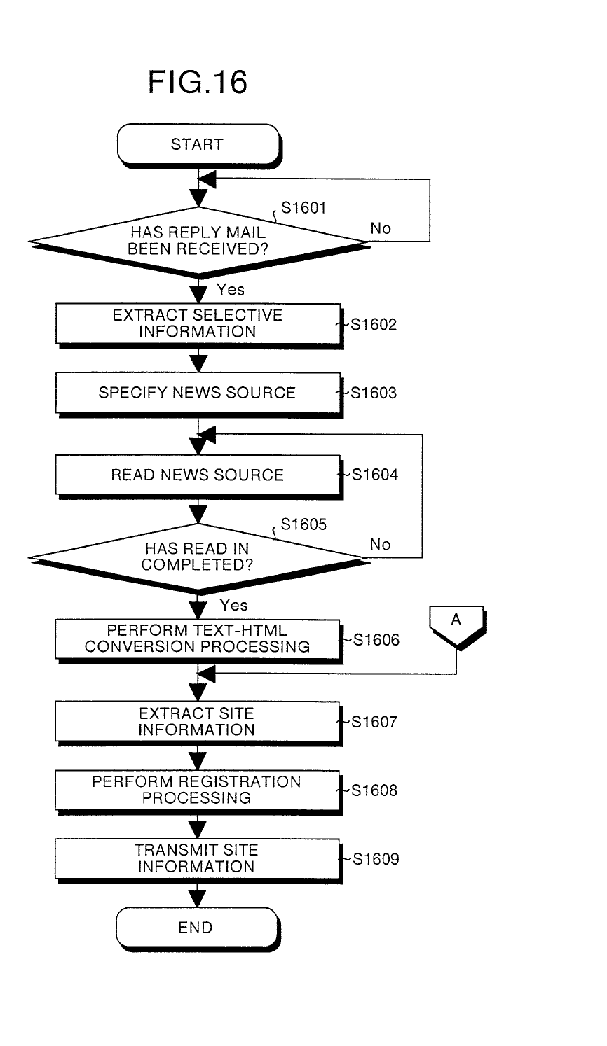

The to-be-distributed information extraction section 805 extracts only predetermined to-be-distributed information from the to-be-distributed information database 801, based on the selective information received by the selective information receiving section 804. The contents (homepage) creation section 806 creates contents, using the to-be-distributed information extracted by the to-be-distributed information extraction section 805. Specifically, the contents creation section 806 creates a homepage in the HTML format. The registration section 807 registers the contents created by the contents creation section 806 in a predetermined site. Detailed contents of the contents (homepage) creation processing in the contents creation section 806 and the registration processing in the registration section 807 will be described later (see FIG. 16 to FIG. 19).

The to-be-distributed information extraction section 805, the contents creation section 806 and the registration section 807 realize its function by the program stored in, for example, the ROM 702, the RAM 703, the HD 705, or the FD 707 shown in FIG. 7, which is executed by the CPU 701. Then, the HP creation process (C) shown in FIG. 1 is realized by the to-be-distributed information extraction section 805, the contents creation section 806, the registration section 807, and the advertising information extraction section 811 described later.

The to-be-distributed information transmission section 808 transmits the to-be-distributed information extracted by the to-be-distributed information extraction section 805 to the predetermined client unit. Here, the advertising information extracted by the advertising information extraction section 811 may be transmitted together with the to-be-distributed information. The to-be-distributed information transmission section 808 realizes its function by the I/F 709 or the like shown in FIG. 7. Then, the mail preparation process (D) shown in FIG. 1 is realized by the to-be-distributed information extraction section 805, the to-be-distributed information transmission section 808 and the advertising information extraction section 811.

The site information transmission section 809 transmits the information related to the site registered by the registration section 807 (site information) to the predetermined client unit, that is, to the client unit to which the selective information received by the selective information receiving section 804 has been transmitted. The site information may transmit with the registration completion notification. The site information need not be transmitted, if the client unit side knows it beforehand. Therefore, it is when the user does not know the site information, or when the site is changed, that the site information is transmitted. The site information transmission section 809 realizes its function by the I/F 709 or the like shown in FIG. 7.

The advertising information database 810 stores advertising information of a plurality of advertisers 102. The same advertiser 102 may store a plurality of different kinds of advertising information therein. This advertising information database 810 corresponds to the advertising information file 111 shown in FIG. 1. The advertising information database 810 realizes its function by, for example, the RAM 703, the HD 705, or the FD 707 shown in FIG. 7.

The advertising information extraction section 811 extracts only predetermined advertising information from the advertising information database 810, based on the to-be-distributed information extracted by the to-be-distributed information extraction section 805. That is to say, the advertising information in a category (see the advertising information file 111 in FIG. 2) same as or similar to the category given to the extracted to-be-distributed information (see the news category file 114 in FIG. 5) is extracted. At this time, the contents creation section 806 creates contents, using the to-be-distributed information extracted by the to-be-distributed information extraction section 805 and the advertising information extracted by the advertising information extraction section 811. The advertising information extraction section 811 realizes its function by the program stored in, for example, the ROM 702, the RAM 703, the HD 705, or the FD 707 shown in FIG. 7, which is executed by the CPU 701.

The calculation section 812 calculates the number of times the advertising information has been extracted from the advertising information database 810 by the advertising information extraction section 811, or the number of times the advertising information has been used for creating the contents by the contents creation section 806. When the number of times the advertising information has been extracted from the advertising information database 810 by the advertising information extraction section 811 coincides with the number of times the advertising information has been used for creating the contents by the contents creation section 806, either of these may be used. If the both numbers do not coincide with each other, either one may be used. As a case where both of these numbers do not coincide with each other, for example, there can be mentioned a case where the extracted information does not appear in the homepage, due to the overall capacity of the contents (homepage), or a case where the same advertising information is separately extracted due to the construction of the advertising information database 810, and either one is inserted in the homepage.

The accounting information preparation section 813 prepares the accounting information based on the number of times calculated by the calculation section 812. Specifically, the accounting information preparation section 813 multiplies the value of the information content of the advertising information by the calculated number of times, to thereby calculate the accounting fee in a predetermined period of time (for example, one month). Then, the accounting information preparation section 813 prepares the accounting information, using the amount of the calculated accounting fee. The accounting information may be prepared for each of the advertising information, or in the case of an advertiser offering a plurality of advertising information, the accounting information may be prepared by gathering these plurality of advertising information for each advertiser.

The prepared accounting information is stored in a predetermined memory area, displayed on the display 708 shown in FIG. 7, output (printed) by the printer 714 or the like, or transmitted to the advertiser 102 via the network. The calculation section 812 and the accounting information preparation section 813 realize its function by the program stored in, for example, the ROM 702, the RAM 703, the HD 705, or the FD 707 shown in FIG. 7, which is executed by the CPU 701.

The information update section 814 updates either one of the information of the to-be-distributed information stored in the to-be-distributed information database 801 and the advertising information stored in the advertising information database 810. At this time, the contents creation section 806 recreates the above contents (homepage) using the updated information, when the information updated by the information update section 814 is the to-be-distributed information extracted by the to-be-distributed information extraction section 805 or the advertising information extracted by the advertising information extraction section 811. The information update section 814 realizes its function by the program stored in, for example, the ROM 702, the RAM 703, the HD 705, or the FD 707 shown in FIG. 7, which is executed by the CPU 701.

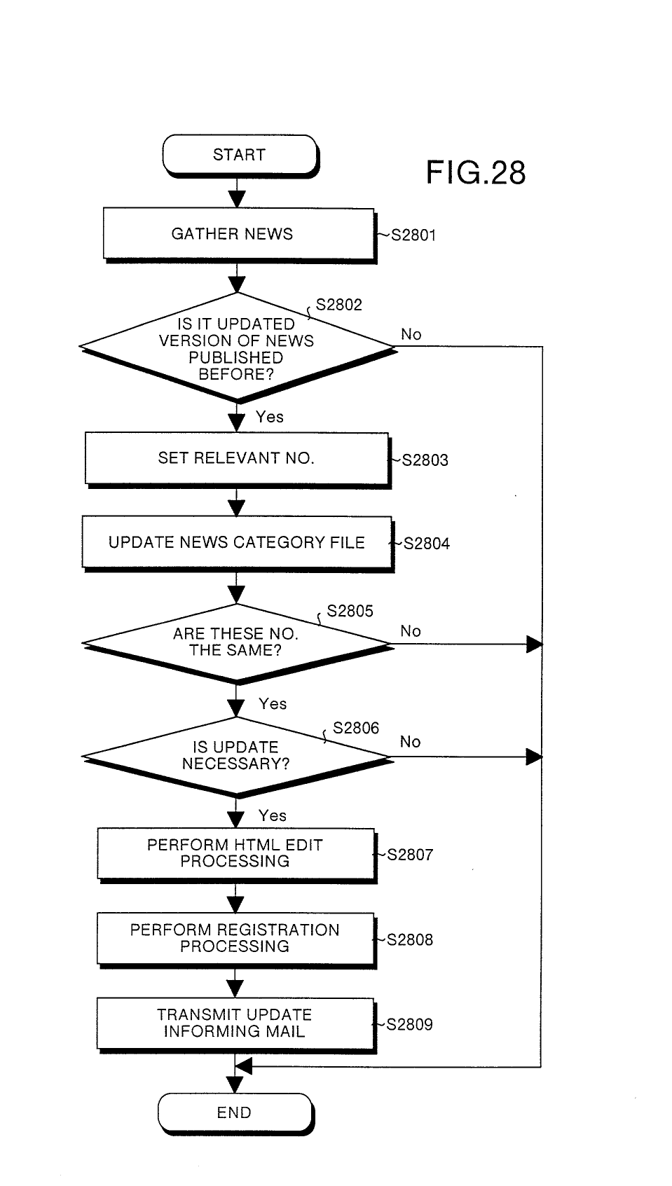

When the above contents are recreated by the contents creation section 806, the recreated information transmission section 815 transmits the information related to the above recreation to the client unit, that is, to the client unit to which the selective information received by the selective information receiving section 804 has been transmitted. Details of the information related to the recreation (update notification mail) will be described later (see step S2809 in FIG. 28). There created information transmission section 815 realizes its function by the I/F 709 or the like shown in FIG. 7.

With regard to the apparatus for distributing information shown in FIG. 8, the description has been given of a case where it is realized by one computer having the hardware configuration shown in, for example, FIG. 7, but the present invention is not limited thereto, and for example, a plurality of servers may be connected by a network such as LAN or Internet, and the functions of the above-described respective constituents are dispersed to and realized by each server. The construction where each function is dispersed to and realized by a plurality of servers will be described later (see FIG. 30).

In FIG. 8, the construction is such that the apparatus for distributing information comprises the to-be-distributed information (news source) database 801 and the advertising information database 810, but the present invention is not limited thereto, and for example, at least either one of the above-described database 801 and 810 may be made connectable via the network such as LAN or Internet. At that time, an interface for accessing the above-described database 801 and 810 via the network is provided in the apparatus for distributing information.

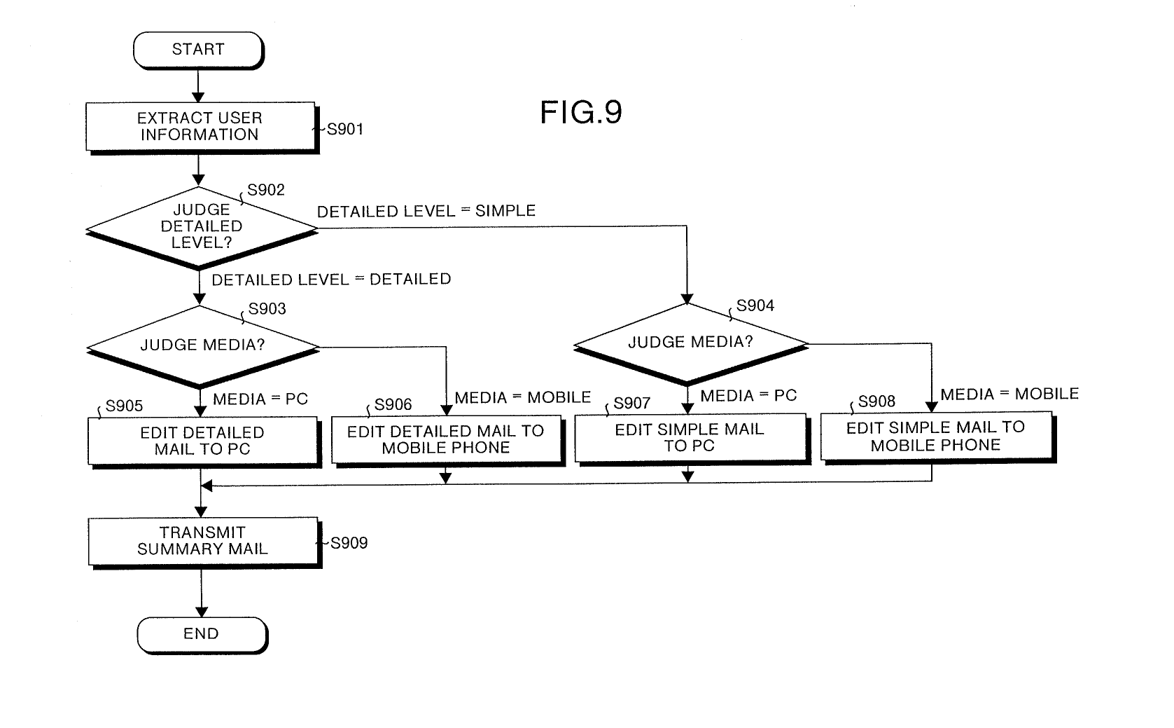

The contents of processing in the transmission process (A) shown in FIG. 1 will now be described. FIG. 9 is a flowchart showing the contents of processing in the transmission process (A). In the flowchart of FIG. 9, the user information is first extracted from the user information file 112 shown in FIG. 1 (step S901). Then, the detailed level is judged from the contents of the “detailed level” item in the user information file 112 (step S902). When the content in the “detailed level” item is “detailed” (step S902: detailed level=detailed), control proceeds to step S903, and when the contents in the “detailed level” item is “simple” (step S902: detailed level=simple), control proceeds to step S904.

The medium is then judged in step S903 and step S904. Specifically, judgment is performed based on the contents in the “media” item in the user information file 112. Then, depending on the kind of each medium, editing of the respective summary mail, that is, editing of a detailed mail to a PC (step S905), editing of a detailed mail to a mobile phone (step S906), editing of a simple mail to a PC (step S907), and editing of a simple mail to a mobile phone (step S908) is performed using the news source file 113.

Specifically, for example, in the case of “detailed level=detailed”, the “title”, “item” and “text” in the news source file 113 are to be transmitted. On the other hand, in the case of “detailed level=simple”, only the “title” and “item” in the news source file 113 are to be transmitted. Thereafter, the edited summary mail is transmitted to the predetermined client unit (step S909).

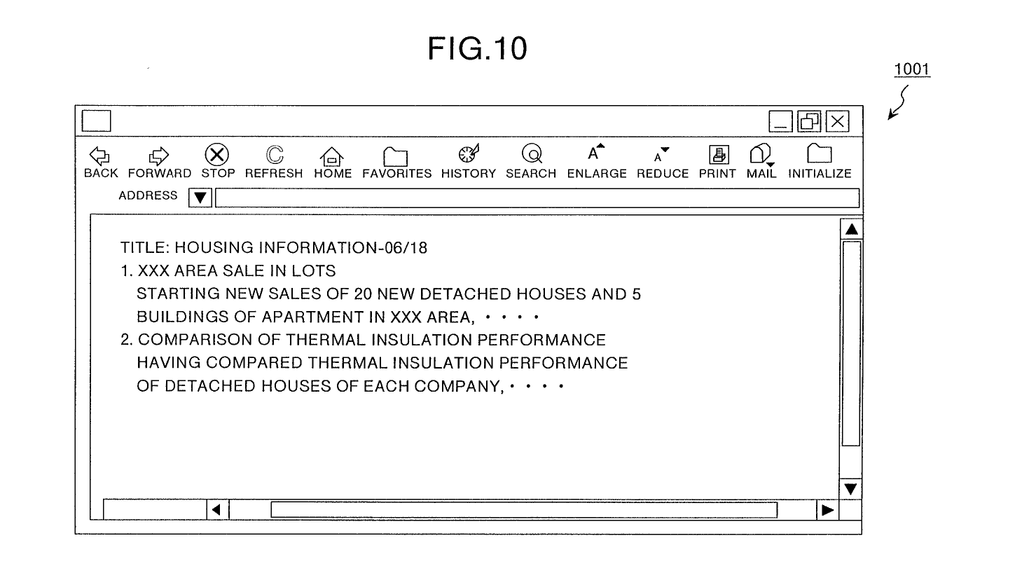

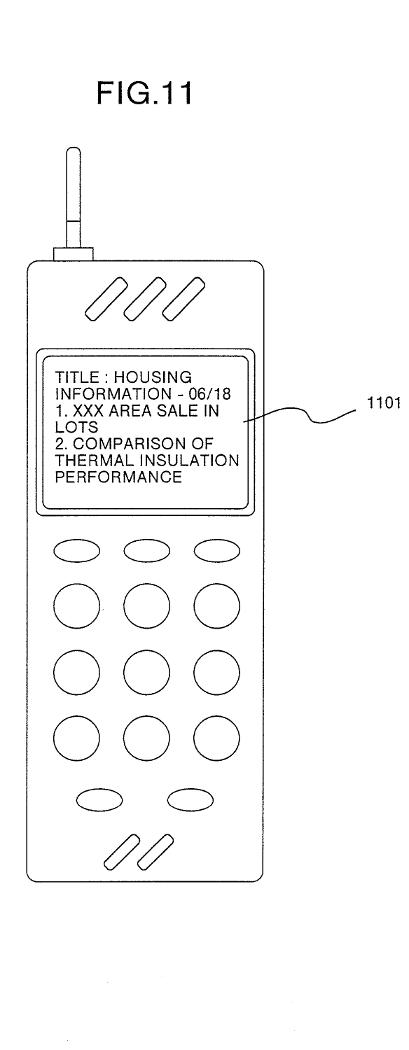

FIG. 10 is a diagram showing one example of a detailed mail to a PC, edited in the transmission process (A). 1001 shows one example of a display screen displayed on a display (large screen) of a personal computer (“PC”), being a client unit to which the summary mail has been transmitted. FIG. 11 is a diagram showing one example of a simple mail to a mobile phone, edited in the transmission process (A). 1101 shows one example of a display screen displayed on a display (small screen) of a mobile phone, being a client unit to which the summary mail has been transmitted.

As described above, in the transmission process (A) the medium that the user 101 uses and the necessary information contents are judged from the user information file 112, to create the to-be-distributed information (news) corresponding thereto by using the news source file 113 and distribute the created to-be-distributed information. Therefore, the contents of the summary mail to be displayed can be changed depending on the performance of the client unit and the size of the display. As a result, the user 101 can confirm effectively the contents of the summary mail. The user can also select the desired format of the summary mail. The selected information is reflected in the user information file 112 shown in FIG. 1. In this manner, the display format of the summary mail can be freely changed, depending on the taste and preference of the user 101 and the application of the summary mail.

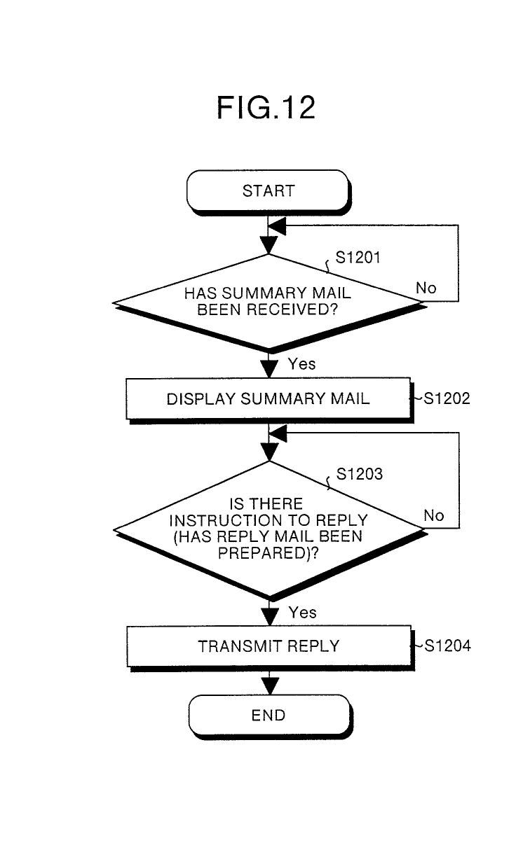

The contents of processing in the reply process (B) in the user terminal unit (client unit) shown in FIG. 1 will new described. FIG. 12 is a flowchart showing the contents of processing in the reply process (B). In the flowchart in FIG. 12, the client unit first judges whether the summary mail has been received or not (step S1201). When waiting for receiving the summary mail, and the summary mail has been received (step S1201: Yes), the received summary mail is displayed on the display of the client unit (step S1202).

It is then judged whether there is an instruction to reply from the user 101 or not, that is, whether the preparation operation of the reply mail described later has been performed or not (step S1203). Waiting for the preparation operation of the reply mail from the user 101, and when the reply mail has been prepared (step S1203: Yes), the prepared reply mail is transmitted (replied) to the apparatus for distributing information (step S1204), to thereby complete a series of reply process. In this manner, the user can select the news that he/she wants the detailed information thereof to be distributed, or the news that he/she wants the detailed information thereof to be developed in the homepage, and can ask for its distribution to the apparatus for distributing information, serving as the distributor.

In FIG. 12, the reply process with respect to the summary mail has been described, but even if it is a detailed mail which is prepared in the mail preparation process shown in FIG. 1 and received, instead of the summary mail, the reply mail can be prepared by the reply process similar to that shown in FIG. 12. By performing such processing, a homepage can be created again in the HP creation process, with regard to the contents confirmed by the detailed mail. This is for making the apparatus for distributing information efficiently act for the user in arrangement processing of the to-be-distributed information, by making the apparatus for distributing information perform arrangement of the detailed information, which has been heretofore performed by a user.

FIG. 13 is a diagram showing one example of a method of preparing a reply mail in the reply process (B). In FIG. 13, 1300 shows one example of a summary mail displayed on the display of the personal computer of the user 101. As method 1 of preparing the reply mail, the user 101 studies the contents of this summary mail and selects only the necessary portion. Alternatively, the user deletes only the unnecessary portion. Then, by performing reply mail operation, the user prepares the reply mail 1301 and transmits the reply mail.

As method 2 of preparing the reply mail, the user 101 studies the contents of this summary mail and prepares a reply mail by inputting only the “title” and the number of “item” of the necessary news information. In the prepared reply mail 1302, the number of “item”, “1” is input, and thereby the news information of “1.xxx area sale in lots, Starting new sales of 20 new detached houses and 5 buildings of apartment in xxx area, . . . ” can be selected.

FIG. 14 is a diagram showing one example of another method of preparing a reply mail in the reply process. In FIG. 14, 1400 shows one example of the summary mail displayed on the display of the mobile phone of the user 101. In order to prepare a reply mail by the mobile phone, the “title” in the summary mail is input to the title in the reply mail (or input automatically by the reply mail preparing processing), and the number of “item” is then input. Subsequently to the input of the number, it is selected (input) whether he/she wants detailed information to be distributed by mail, or wants detailed information to be inserted in the homepage.

When the user wants detailed information to be distributed by mail, as shown in the reply mail 1401, the user inputs the number “1”, then “-” and “ML”. On the other hand, when the user wants detailed information to be inserted in the homepage, as shown in the reply mail 1402, the user inputs the number “1”, then “-” and “HP”.

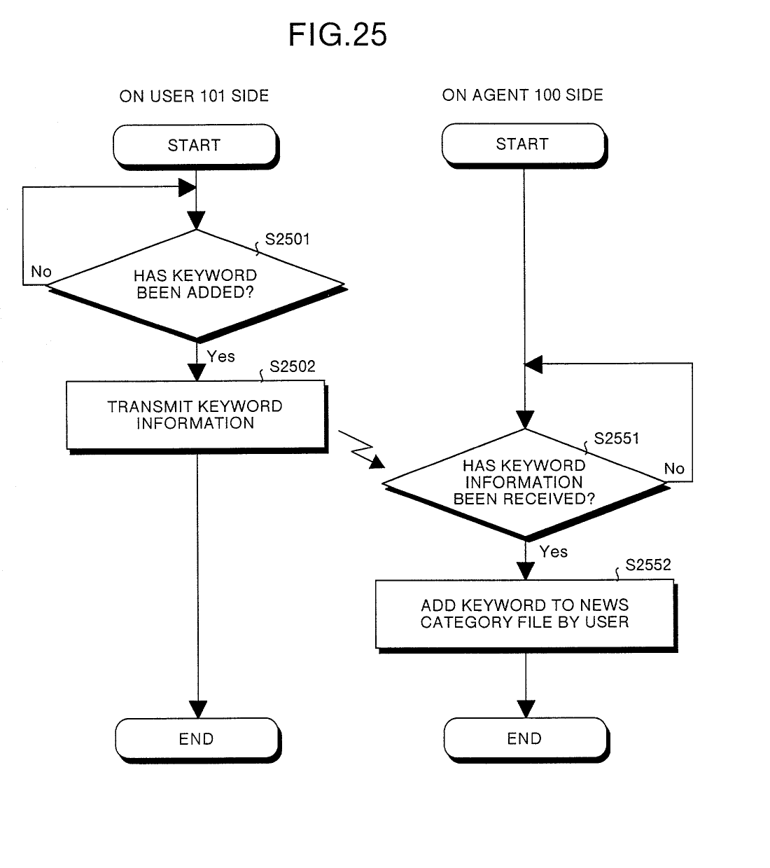

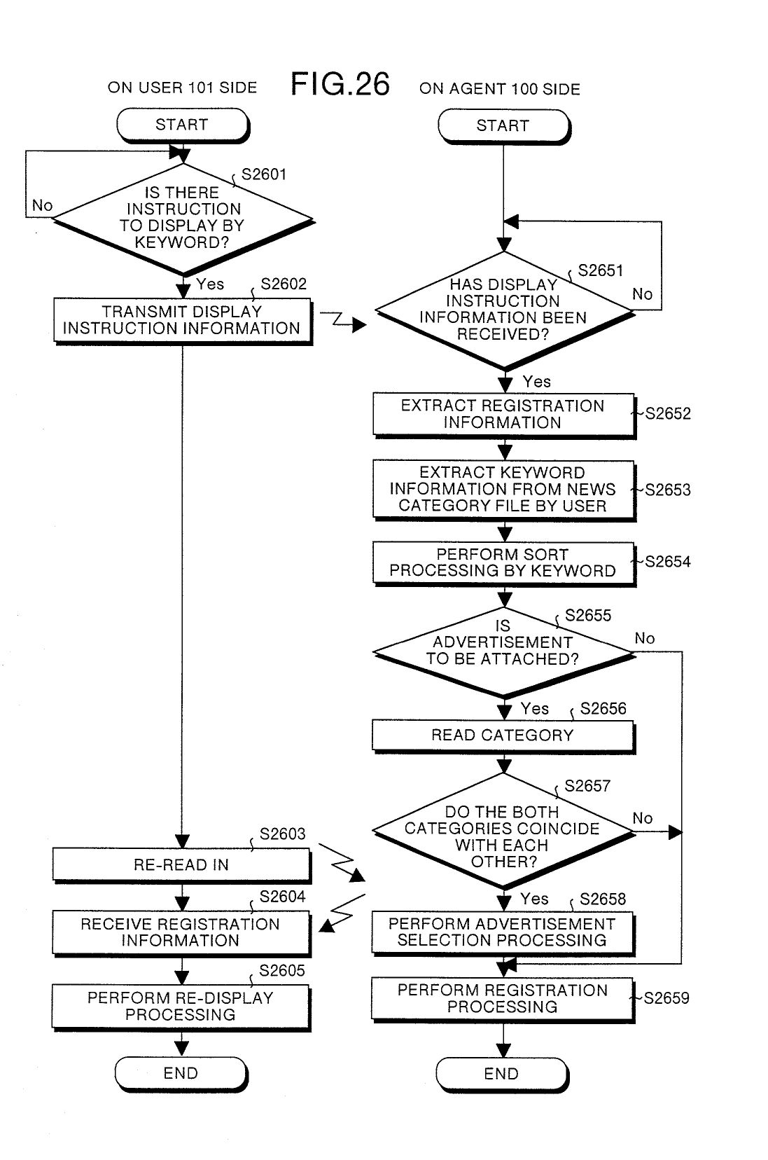

Moreover, in addition to the selective information, a keyword for classifying the news information maybe input, using the reply mail of the mobile phone. FIG. 15 is a diagram showing one example of another method of preparing a reply mail in the reply process. In FIG. 15, as the reply mail 1501 with respect to the summary mail 1400, the user inputs the number “1”, then “#” and “newly built” as the keyword. Thereby, the keyword “newly built” is added in the news information of the number “1” of the “item”. Detailed contents related to the keyword will be described later (see FIG. 25 and FIG. 26).

As described above, in the reply process (B), by preparing a reply mail with respect to the summary mail and transmitting the reply mail, a desired form can be selected from the following four kinds of processing:

(1) To insert the selected news information only in HP;

(2) To specify the selected news information as the to-be-distributed information and transmit (distribute) the detailed information thereof;

(3) To specify the selected news information as the to-be-distributed information and transmit (distribute) the detailed information thereof, as well as being inserted in HP;

(4) To specify the selected news information as the to-be-distributed information and transmit (distribute) the detailed information thereof, and the contents of the to-be-distributed information inserted in HP upon confirmation.

The contents of processing in the HP creation process (C) shown in FIG. 1, in particular, the contents of the HTML edit processing (C)-1 will now be described. FIG. 16 is a flowchart showing the contents of processing in the HP creation process (C). FIG. 17 is a diagram showing the contents of the HTML edit processing (C)-1 in the HP creation process. In the flowchart in FIG. 16, at first, it is judged whether a reply mail from a client unit has been received or not (step S1601). Here, as described above, the reply mail may be a reply mail with respect to the detailed mail transmitted by the mail preparation process (D).

In step S1601, waiting for receiving the reply mail, and when the reply mail is received (step S1601: Yes), the selective information (for example, a reply mail 1701 shown in FIG. 17) is extracted from the received reply mail (step S1602). The news source selected by the user is specified from the selective information (step S1603), and the specified news source is read from the news source file 113 as shown in FIG. 17 (step S1604). Waiting for the completion of read in of the specified news source, and when the read in has been completed (step S1605: Yes), by performing the text—html conversion processing, the contents in the HTML format is created (step S1606).

The information related to the site in which the created contents are registered (site information) is then extracted from the user information file 112 (step S1607). However, when the created contents are to be registered in a new site, the site information newly set by a site setting section (not shown) is extracted. Then, the contents created in a predetermined site based on the extracted site information are registered (step S1608). The registered contents are displayed in the user area (details of news) in the homepage 120 shown in FIG. 1, as the contents in the browser screen 121 shown in FIG. 17.

Moreover, according to need, the site information is transmitted to the contents unit (step S1609). The contents unit, being a destination to which the site information is transmitted, may be the contents unit from which the reply mail has been transmitted, or a contents unit related to the created contents. The related contents unit stands for a case where, for example, the user has registered in advance a contents unit (a mobile phone or the like) of a separate medium from the contents unit (PC or the like). The contents of the transmitted site information includes a message, for example, “A homepage has been created and registered, based on the reply mail transmitted at 14:20 on Jun. 12, 2001. The site where the homepage is registered is “http://www.***.fujitsu.ne.jp”. The registered period of the homepage is for two months.”.

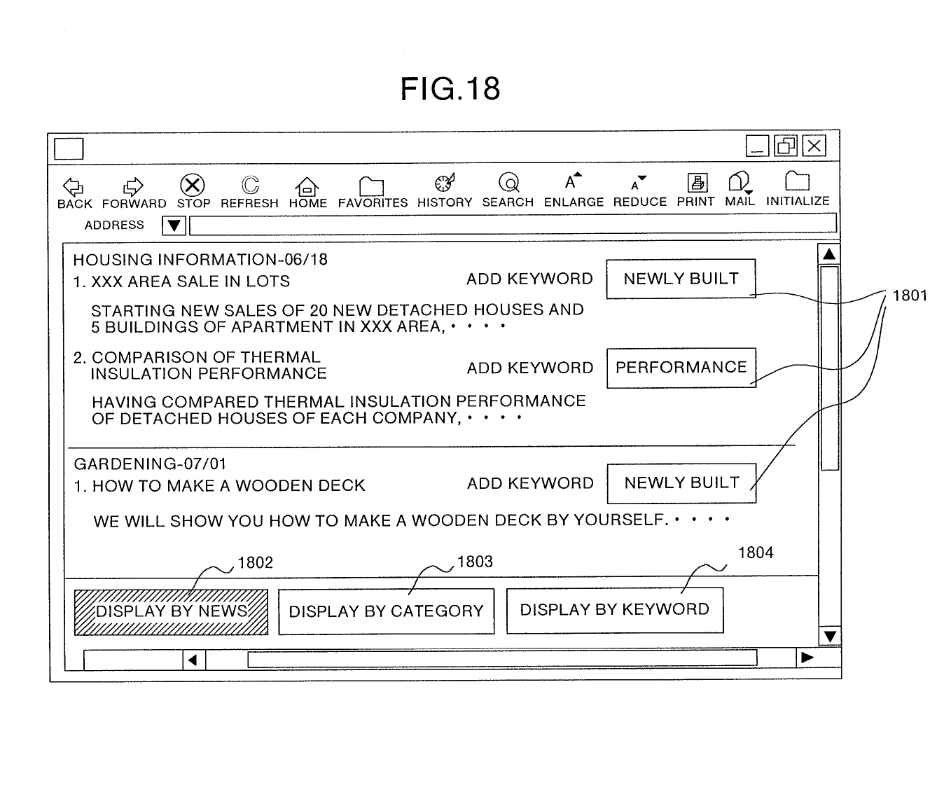

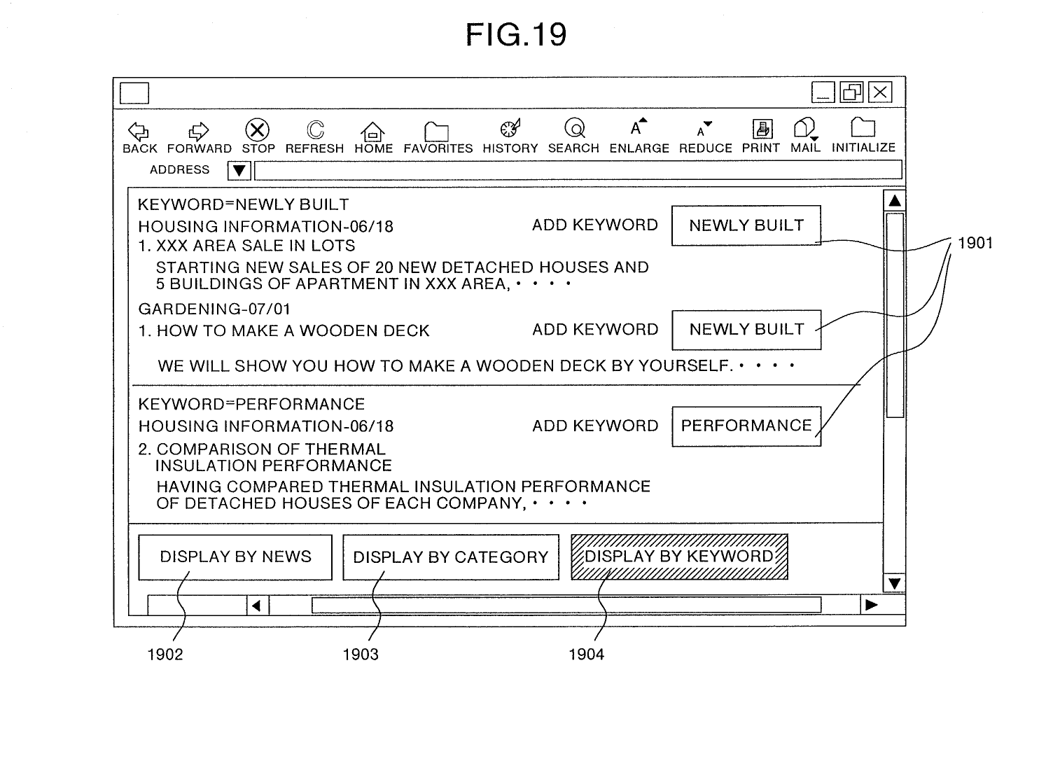

FIG. 18 and FIG. 19 are diagrams showing one example of a display layout of a homepage created by the HP creation process. FIG. 18 shows one example of a display by news, and FIG. 19 shows one example of a display by keyword. Detailed contents of the keyword addition and switching of the display will be described later.

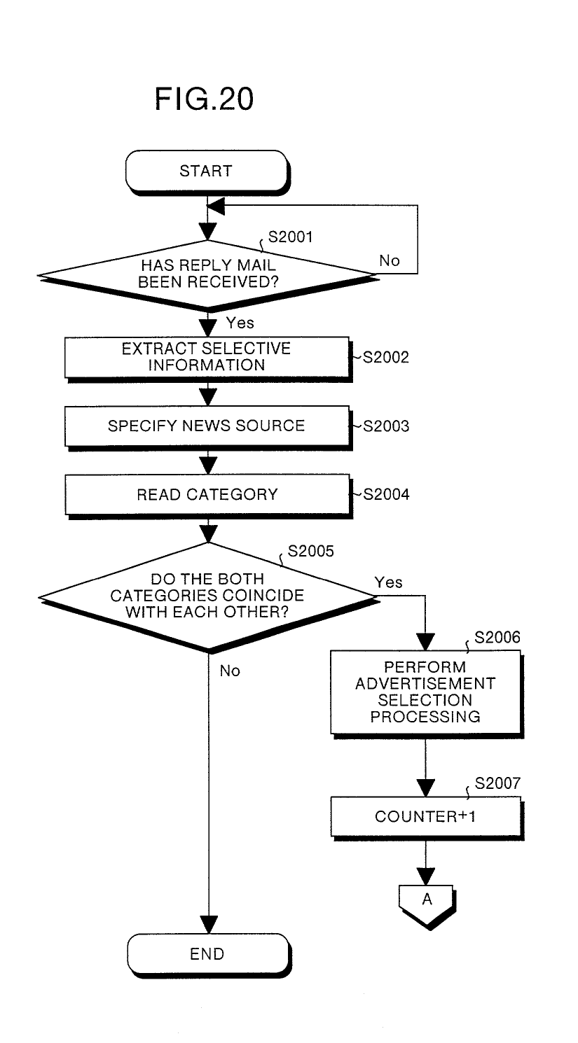

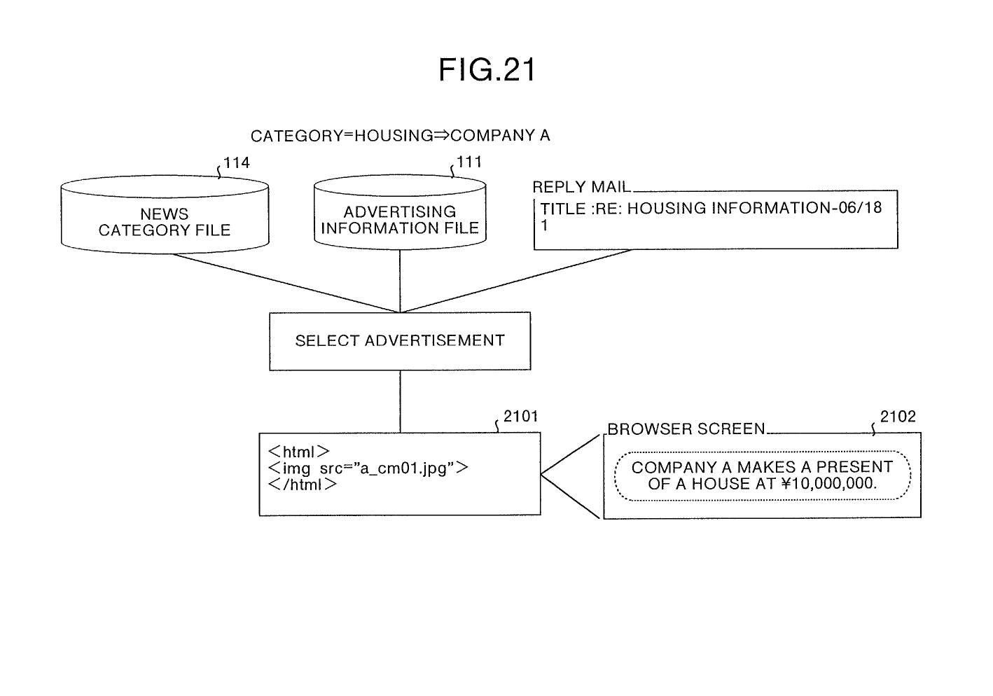

Contents of processing in the HP creation process (C) shown in FIG. 1, particularly, contents of the advertisement selection processing (C)-2 will now be described. FIG. 20 is a flowchart showing the contents of processing in the HP creation process (C), particularly, in the advertisement selection processing (C)-2. FIG. 21 is a diagram showing the contents of the advertisement selection processing (C)-2. In the flowchart in FIG. 20, each step of from step S2001 to S2003 are similar to the contents in each step in step S1601 to S1603 in the flowchart shown in FIG. 16, and hence the description thereof is omitted.

The information related to the specified news source (news category) is then read from the news category file 114 as shown in FIG. 21 (step S2004). It is then judged whether the read news category (“housing” in FIG. 21) coincides with (or resembles) the categories stored in the advertising information file 111 or not, in other words, whether the category “housing” is in the “category” item in the advertising information file 111 (or may not necessarily coincide therewith, but a category similar to the category “housing” in the meaning is in the “category” item in the advertising information file 111) or not (step S2005).

It is judged whether the read news category coincides with (resembles) the categories stored in the advertising information file 111, in one-to-one correspondence, or a plurality of news categories may be matched off against the categories stored in the advertising information file 111 to thereby judge whether the both categories coincide with each other (or may not necessarily coincide with each other, but there is a similar meaning in the both categories) or not. It is because there are normally many cases where the advertising information is inserted one in the vicinity of the display area of a plurality of news information, with respect to the plurality of news information. Specifically, when the first news category is “X” and the second news category is “Y”, only when the categories stored in the advertising information file 111 include both categories of “X” and “Y”, it may be judged that the both categories coincide with each other.

If these categories do no coincide with each other, that is, the matching category does not exist in the advertising information file 111 (step S2005: No), the advertisement selection processing is finished without doing anything. On the other hand, if these categories coincide with each other (step S2005: Yes), the corresponding advertising information is selected from the advertising information file 111, and the selected advertising information is subjected to the processing for making it to HTML format, and is added to the contents created in step S1606 in FIG. 16 (step S2006).

Specifically, as shown in FIG. 21, it can be judged that the category is “Housing” from the reply mail, from the news category file 114 (see FIG. 5). It can be also judged that the advertising information having the category consistent with this category “Housing” is of company “A”, from the advertising information file 111 (see FIG. 2). When this advertising information “a_cm01.jpg” of company “A” is processed into the HTML format, as shown in 2101, the browser screen display as shown in 2102 is obtained. This display content is displayed in the advertising area 122 in the homepage 120 shown in FIG. 1.

Returning to FIG. 20, in step S2007, the counter (calculation section 812 shown in FIG. 8) provided for respective advertising information is incremented by 1 (step S2007), in order to show that the insertion frequency in the homepage is increased by 1 with respect to the selected advertising information. Thereafter, control proceeds to step S1607 shown in FIG. 16.

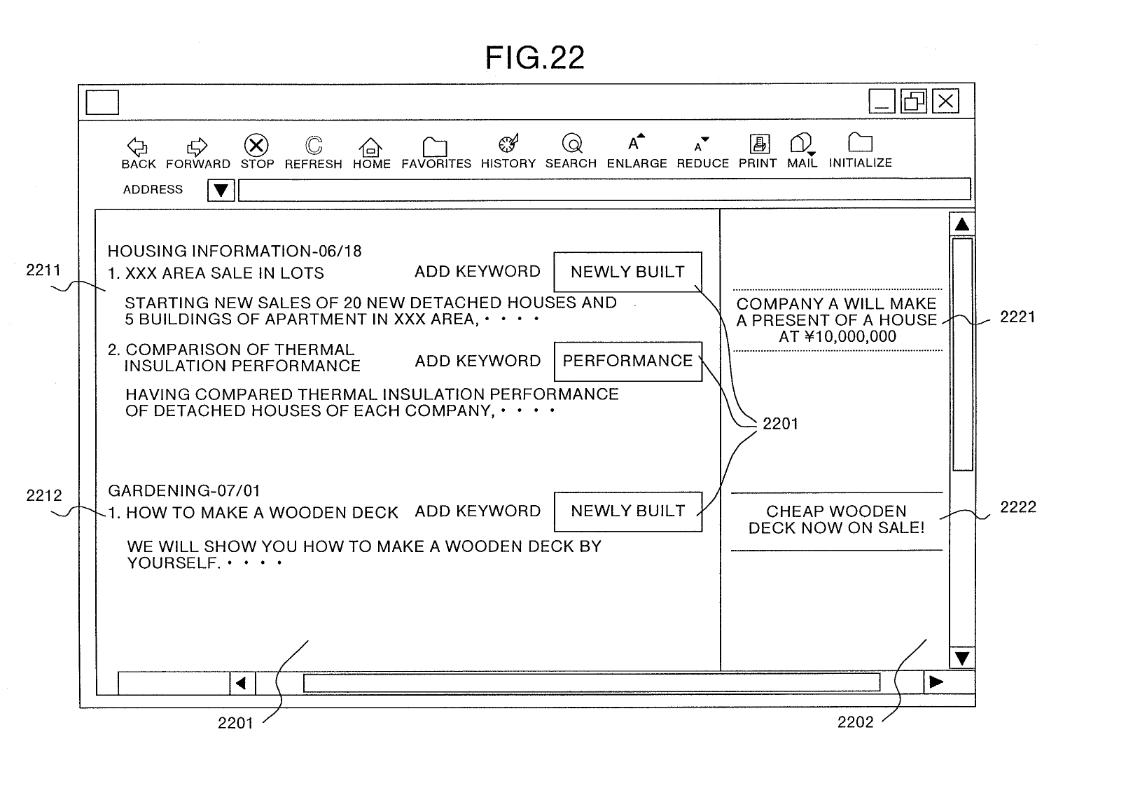

FIG. 22 is a diagram showing an example of a display layout of a homepage created by the HP creation process. It is a homepage created by the processing (particularly, the advertisement selection processing (C)-2) in the HP creation process (C). In FIG. 22, the details of the news are displayed in the user area 2201, together with the advertising information displayed in the advertising area 2202.

Based on the contents of the news (housing-allied information), the advertising information related to the contents (information related to the house present) is displayed in the area 2221 close to the news display area 2211 in the advertising area 2202. With respect to the information related to “Gardening”, the advertising information related to the “wooden deck sale” is displayed in the area 2222 close to the display area 2212 thereof in the advertising area 2202. In this manner, by displaying the contents of the news and the advertising contents in the same page, associated with each other, convenience with respect to the user can be improved, as well as improving the advertising effect of the advertiser.

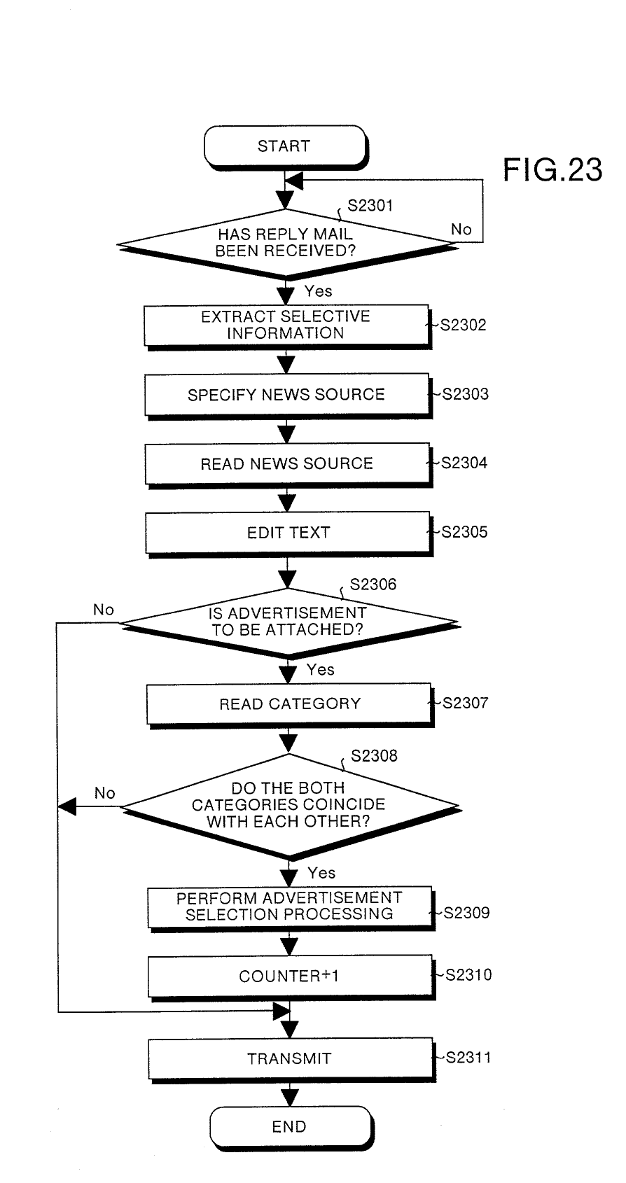

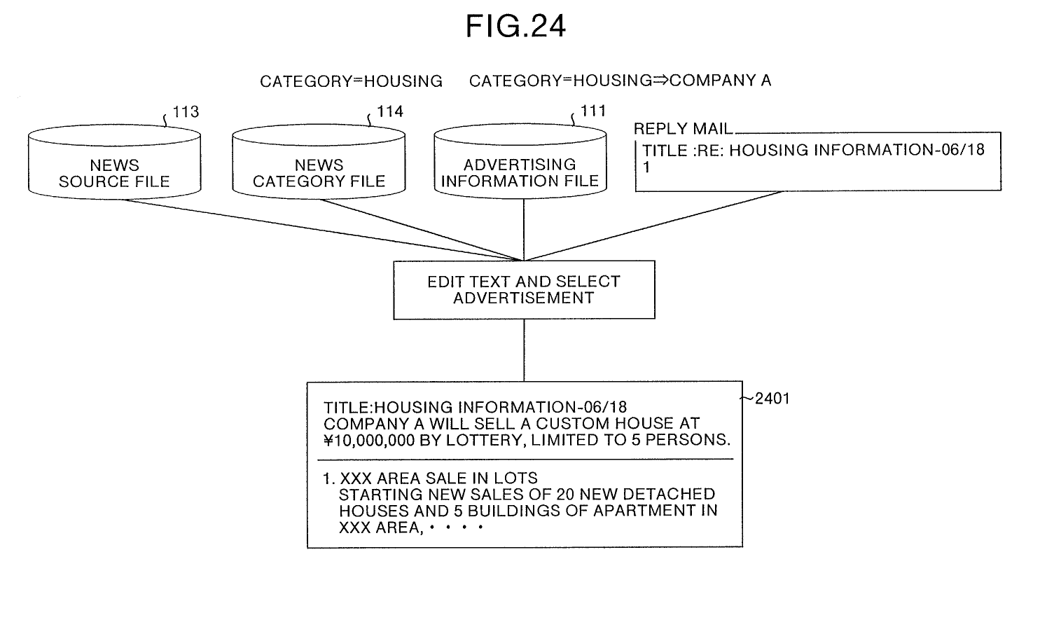

Contents of processing in the mail preparation process (D) shown in FIG. 1 will now be described. FIG. 23 is a flowchart showing the contents of processing in the mail preparation process (D). FIG. 24 is also a diagram showing the contents in the mail preparation process (D) (text editing and advertisement selection). In the flowchart in FIG. 23, each step of from step S2301 to S2304 has the same contents as each step of from step S1601 to S1604 shown in FIG. 16, and hence its description is omitted. Read in of the news source in step S2304 is performed from the news source file 113 shown in FIG. 24. When the read news source is not a text format, text editing is performed to make it text format (step S2305).

It is then judged whether an advertisement is attached to the detailed mail or not (step S2306). In the case of a mail without advertisement (step S2306: No), control proceeds to step S2311 without doing anything. On the other hand, when an advertisement is attached, that is, in the case of a mail with advertisement (step S2306: Yes), the information related to the specified news source (news category) is read in from the news category file 114 (step S2307), as shown in FIG. 24. Then, it is judged whether the read news category (“Housing” in FIG. 24) coincides with the categories stored in the advertising information file 111, in other words, the category “Housing” exists in the “category” item in the advertising information file 111 or not (step S2308).

If the both categories do not coincide with each other, that is, the matching category does not exist in the advertising information file 111 (step S2308: No), control proceeds to step S2311 without doing anything. In this case, no advertisement is inserted. On the other hand, when the both categories coincide with each other (step S2308: Yes) the corresponding advertising information is selected from the advertising information file 111, and the selected advertising information is processed into a text. Specifically, as shown in FIG. 24, it can be judged that the category is “housing” from the reply mail, from the news category file 114 (see FIG. 5). Also, it can be judged that the advertising information having the category consistent with this category “Housing” is of company “A”, from the advertising information file 111 (see FIG. 2). When this advertising information of company “A” is processed into a text, the browser screen display as shown in 2401 is obtained. This display content is displayed in the mail 123 shown in FIG. 1.

Returning to FIG. 23, in step S2310, the counter (calculation section 812 shown in FIG. 8) provided for respective advertising information is incremented by 1 (step S2310), in order to show that the insertion frequency in the homepage is increased by 1 with respect to the selected advertising information. Thereafter, control proceeds to step S2311. In step S2311, the prepared mail is transmitted to the client unit to thereby complete a series of processing.

The contents of keyword adding processing will now be described. FIG. 25 is a flowchart showing the contents in the keyword adding processing according to this embodiment of the present invention. In the flowchart in FIG. 25, at first on the user 101 side (client unit), it is judged whether a keyword has been added or not (step S2501).

The keyword can be added by the user by inputting characters in the keyword input column 1801, 1901 and 2201 in FIG. 18, FIG. 19 or FIG. 22, using the keyboard or the like. Moreover, by registering frequently used keywords beforehand, displaying the already registered keywords by a pull-down menu or the like (not shown), and selecting a desired keyword using a pointing device such as a mouse, the keyword can be added. In the case of a mobile phone, as shown in FIG. 15, the keyword can be added by a reply mail.

Waiting for the keyword being added, in step S2501, when the keyword is added (step S2501: Yes), the keyword information related to the keyword is transmitted to the agent 100 side (step S2502).

On the agent 100 side, waiting for receiving the keyword information (step S2551), when the keyword information is received (step S2551: Yes), the added keyword is added (stored) in the “keyword” item in the news category file by user 115 (step S2552), to thereby terminate the processing. As a result, the keyword is added.

The keyword can be normally registered only one, and if processing of adding another keyword different from the keyword already registered is performed, the new keyword is overwritten on the current keyword and registered. Moreover, the construction may be such that a plurality of keywords can be registered. In this case, though not shown, the construction may be such that editing operation such as deletion and change of the keyword, and editing processing of the keyword accompanying the editing operation can be performed.

Contents of re-display processing of the display screen will now be described. FIG. 26 is a flowchart showing the contents in the screen re-display processing according to this embodiment of the present invention. In the flowchart in FIG. 26, at first on the user 101 side (client unit), it is judged whether an instruction to display by keyword has been input by a user or not (step S2601).

With regard to the display instruction, for example, as shown in FIG. 18, display instruction buttons 1802 to 1804 for display instruction are displayed at the lower side of the display screen. Moreover, the display instruction buttons 1802 to 1804 indicate that which display form is being taken at present by means of a change of color of the button itself (reversing or the like). In FIG. 18, it is shown that the color of the “Display by news” button 1802 is reversed, and the display screen in FIG. 18 is sorted by news.

As shown in FIG. 18, in the state with the screen being sorted by news, by pushing the “Display by keyword” button 1804, display by keyword is instructed.

In step S2601, waiting for having an instruction to display by keyword, and when the display by keyword is instructed (step S2601: Yes), the display instruction information is transmitted to the agent 100 side (step S2602).

On the agent 100 side, waiting for receiving the display instruction information (step S2651), and when the display instruction information is received (step S2651: Yes), the registration information (homepage) created by the HP creation process (C) and registered by the registration section 807 shown in FIG. 8 is extracted (step S2652) The keyword stored in the “keyword” item in the news category file by user 115 is then extracted, based on the received display instruction information (step S2653), and based on the extracted keyword, the contents of the homepage extracted in step S2652 is sorted (step S2654).

It is then judged whether an advertisement is to be attached to the detailed mail or not (step S2655). In the case of not attaching advertisement (step S2655: No), control proceeds to step S2659 without doing anything. On the other hand, when an advertisement is attached (step S2655: Yes) the information related to the specified news source (news category) is read in from the news category file 114 or the news category file by user 115 (step S2656) It is then judged whether the read news category coincides with (or resembles) the categories stored in the advertising information file 111, in other words, the above-described read category exists in the “category” item in the advertising information file 111 or not (step S2657).

If the both categories do not coincide with each other, that is, coincided categories are not exist in the advertising information file 111 (step S2657: No), control proceeds to step S2659 without doing anything. On the other hand, when the both categories coincide with each other (step S2657: Yes), the corresponding advertising information is selected from the advertising information file 111, and the selected advertising information is processed into an HTML format (step S2658), and control proceeds to step S2659. In step S2659, the registration processing similar to that in step S1608 shown in the flowchart in FIG. 16 is performed. As a result, a series of processing on the agent 100 side is terminated.

Then, on the user 101 side, re-read in is performed (step S2603). As a result, the registration information registered in step S2659 is received (step S2604). Thereafter, re-display processing is performed (step S2605) to thereby terminate a series of processing. The display shown in FIG. 19 is one example of the display screen which is subjected to the re-display processing.

As described above, by changing the order of display of the news information, the display position of the advertising information is also changed. Generally, in many cases, the advertising information is inserted in the area close to the news information in the display area with respect to a plurality of news information. Therefore, when the combination of the news information is changed by changing the order of display of the news information, the selected advertising information is also changed. That is to say, depending on the contents of the re-display, the advertising information selected before may not be selected anymore, and on the contrary, advertising information that has not been selected before may be selected.

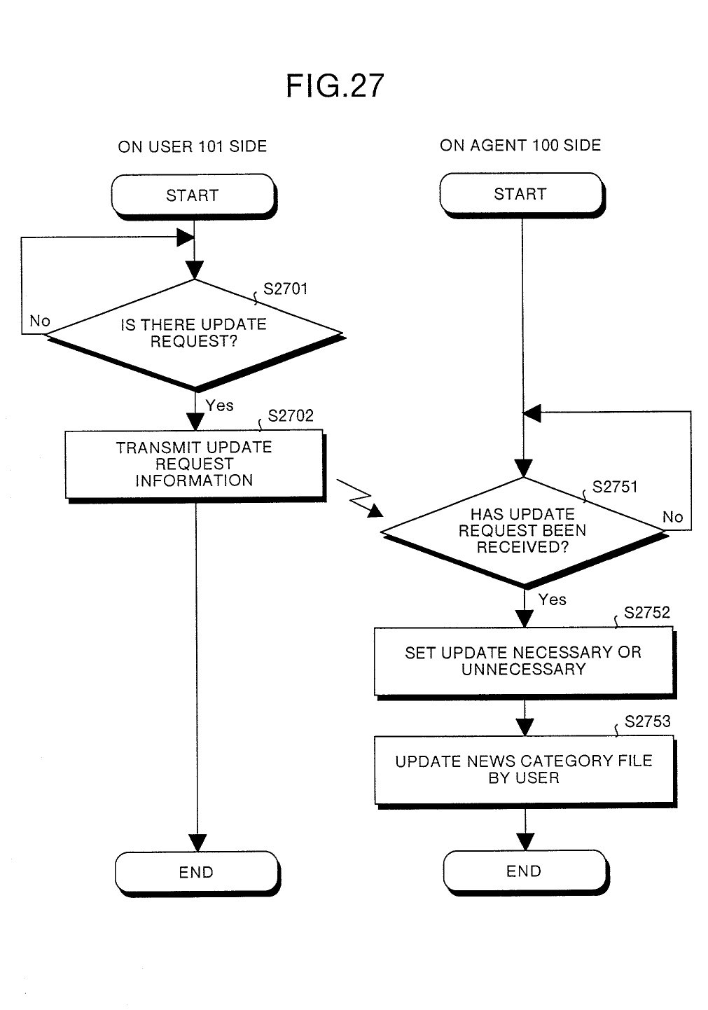

The contents of the update processing of the news source and the advertising information will now be described. FIG. 27 is a flowchart showing the contents in the update request processing according to this embodiment of the present invention. In the flowchart in FIG. 27, at first on the user 101 side (client unit), it is judged whether there is an update request from the user or not (step S2701).

With respect to the update request, though not shown, for example, an instruction button instructing whether update is performed for respective news or not is displayed on the display screen of the client unit, and if this instruction button is pushed, it is judged that there has been an update request.

In step S2701, waiting for receiving the update request, and when the update request is received (step S2701: Yes) the information related to the update request (update request information) is transmitted to the agent 100 side (step S2702).

On the agent 100 side, waiting for receiving the update request information (step S2751), and when the update request information is received (step S2751: Yes), setting whether update is necessary or unnecessary is performed (step S2752), to thereby update the “update necessary or unnecessary” item in the news category file by user shown in FIG. 1 (step S2753). When the one once set to “update necessary” is changed to “update unnecessary”, this can be done by performing the same processing as the processing described above.

FIG. 28 is a flowchart showing the contents in the update processing according to this embodiment of the present invention. In the flowchart in FIG. 28, the information update section 814 shown in FIG. 8 first gathers news (step S2801). It is then judged whether the gathered news is the updated version of the news published before or not (step S2802). Here, when it is not the updated version (step S2802: No), the processing is terminated.

On the other hand, in step S2802, if it is the updated version of the news published before (step S2802: Yes), relevant No. is then set (step S2803), and the “Relevant No.” item in the news category file 114 is updated (step S2804). The contents in the “Relevant No.” item in the news category file 114 and the contents in the “No.” item in the news category file by user 115 are compared, to thereby judge whether the both coincide with each other or not (step S2805).

In step S2805, when the both do not coincide with each other (step S2805: No), the processing is terminated. On the other hand, the both coincide with each other (step S2805: Yes), it is then judged whether the “update necessary or unnecessary” item in the news category file by user 115 becomes “update necessary” or not (step S2806). Here, in the case of “update unnecessary” (step S2806: No), the processing is terminated. On the other hand, in the case of “update necessary” (step S2806: Yes), the HTML edit processing is performed (step S2807), and the content shaving subjected to the HTML edit processing is registered (step S2808).

Then, the update informing mail is transmitted to the contents unit by the recreated information transmission section 815 shown in FIG. 8 (step S2809), to thereby terminate a series of processing. The update informing mail contains information informing that it has been updated and that date and time, by the contents of, for example, “This news has been updated on Jun. 12, 2001, at 10:00 am (last time), and on Jun. 9, 2001, at 10:00 pm (at the time before last).”. If there are several updates, the information contains the date and time information for each update. Moreover, what is updated is not only news, but also may include advertising information. In the case of the advertising information, transmission of the update informing mail (step S2809) is not necessary.

In this manner, the contents of the news information, of which insertion into the HP has been requested, can be updated. Therefore, even in a case where predetermined time has passed since request of insertion into the HP has been made, the contents of the inserted news can be used sufficiently practically. Moreover, it may be set so as not to update, so that it can be prevented that the past information is rewritten by new information, thereby making impossible to refer to that information.

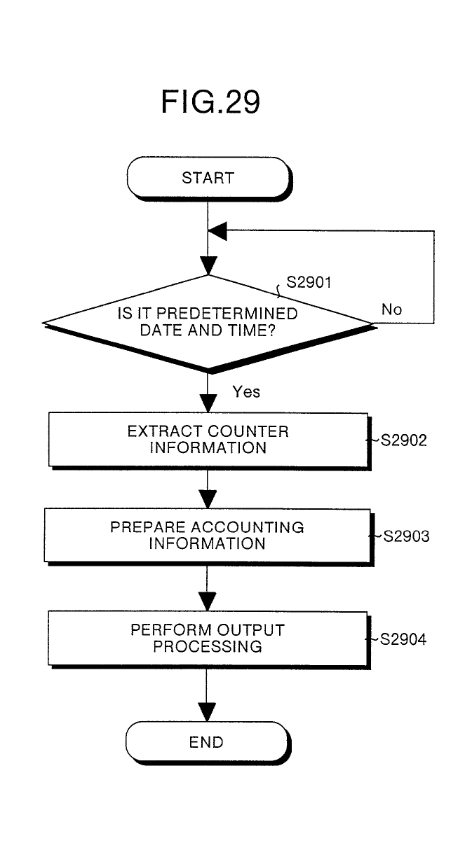

Contents of accounting information preparation processing according to this embodiment of the present invention will now be described. FIG. 29 is a flowchart showing the contents in the accounting information preparation processing according to this embodiment of the present invention. In the flowchart in FIG. 29, the accounting information preparation section 813 shown in FIG. 8 comprises a timer (not shown), and it is judged whether it is predetermined date and time which is determined beforehand or not (step S2901).

The predetermined date and time may be predetermined date and time at the end of each month, or predetermined time interval (for example, for every 10 days). In step S2901, waiting for becoming the predetermined date and time, and when it becomes the predetermined date and time (step S2901: Yes), the counter information is extracted from the calculation section 812 shown in FIG. 8 (step S2902). Then, the accounting information preparation section 813 shown in FIG. 8 prepares accounting information (step S2903), and performs output processing of the prepared accounting information (step S2904), to thereby terminate the processing.

The contents of the system structure for realizing the method of distributing information according to this embodiment of the present invention will now be described. FIG. 30 is a diagram showing a system structure of a system for realizing the method of distributing information according to this embodiment of the present invention. In FIG. 30, in the agent (news distributor) 100, a DB server 3001 for advertisement control, a DB server 3002 for user control, a DB server 3003 for news control, a mail server 3004, an APL server 3005, and a Web server 3006 are connected to each other, via a network 3000 such as LAN or Internet.

The DB server 3001 for advertisement control controls advertisement DB 3011. In the same manner, the DB server 3002 for user control controls user DB 3012, the DB server 3003 for news control controls news DB 3013, and the Web server 3006 controls the Web (data) 3016.

When it is compared with FIG. 1, the advertising information file 111 corresponds to the advertisement DB 3011, the user information file 112 corresponds to the user DB 3012, the news source file 113 corresponds to the news DB 3013, and the news category file 114 and the news category file by user 115 correspond to the user DB 3012 or the news DB 3013.

Also, the transmission process (A) corresponds to the mail server 3004, the HP creation process (C) and the mail preparation process (D) correspond to the APL server 3005. The APL server 3005 performs various processing according to the contents of the reply mail.

When it is compared with FIG. 8, the to-be-distributed information (news) database 801 corresponds to the news DB 3013, and the intensive information generation section 802 corresponds to the mail server 3004 or the APL server 3005. The intensive information transmission section 803, the selective information receiving section 804, the to-be-distributed information transmission section 808, the site information transmission section 809 and the recreated information transmission section 815 correspond to the mail server 3004. The to-be-distributed information extraction section 805 corresponds to the DB server 3003 for news control.

The contents (homepage) creation section 806 corresponds to the APL server 3005, and the registration section 807 corresponds to the Web server 3006. The advertising information extraction section 811 corresponds to the DB server 3001 for advertisement control. The calculation section 812 and the accounting information preparation section 813 correspond to the APL server 3005. The information update section 814 corresponds to the DB server 3001 for advertisement control and the DB server 3003 for news control.

As described above, according to this embodiment, the intensive information (summary mail) gathering all of or a part of the to-be-distributed information (news source) is transmitted to a client unit of a user 101, the selective information (reply mail) related to the to-be-distributed information selected from a plurality of to-be-distributed information gathered by the intensive information is received, and based on the received selective information, only predetermined to-be-distributed information is extracted, to thereby create contents (homepage) using the extracted to-be-distributed information, and the created contents are registered in a predetermined site. As a result, the user 101 only selects the desired to-be-distributed information from the transmitted intensive information, to automatically create the homepage consisting of the desired to-be-distributed information (and the advertising information). Hence, the user can read the desired news information on the Web browser at any place, without being limited to a terminal unit.

Furthermore, the intensive information (summary mail) gathering all of or a part of the to-be-distributed information (news information) is transmitted to the client unit of the user 101, the selective information related to the to-be-distributed information (reply mail) selected from a plurality of to-be-distributed information gathered by the intensive information is received, and based on the received selective information, only predetermined to-be-distributed information is extracted, and the extracted to-be-distributed information (detailed mail) is transmitted to the client unit of the user 101. Therefore, the user 101 only selects the desired to-be-distributed information from the transmitted intensive information, to transmit a mail consisting of only the desired to-be-distributed information (and the advertising information).

Moreover, the intensive information (summary mail) gathering all of or a part of the news information is transmitted to the client unit of the user 101, the first selective information (first reply mail) related to the to-be-distributed information selected from a plurality of to-be-distributed information gathered by the intensive information is received, and based on the received first selective information, only predetermined to-be-distributed information is extracted, and the extracted to-be-distributed information (detailed mail) is transmitted to the client unit of the user 101. Then, the second selective information (second reply mail) related to the to-be-distributed information selected from the transmitted to-be-distributed information is received, to create contents (homepage), using the to-be-distributed information selected by the received second selective information, and the created contents are registered in a predetermined site. Therefore, the user 101 confirms the detailed information, and by only selecting the detailed information, a homepage consisting of only the detailed information (and the advertising information) is automatically created.

Furthermore, based on the extracted to-be-distributed information, only the predetermined advertising information is extracted, and the contents (homepage) are created by using the extracted to-be-distributed information and the extracted advertising information. As a result, advertising information is automatically selected based on the desired to-be-distributed information of the user 101, and only the advertising information having contents matched to the taste and preference of the user 101 is inserted, thereby enabling effective advertising for the advertiser 102.

Moreover, since the number of times the advertising information has been extracted, or the number of times the advertising information has been used for creation of the contents (homepage) is calculated for each advertising information, and accounting information is prepared based on the calculated number of times, proper charging based on the advertising effect can be made.

Furthermore, when the updated information is the extracted to-be-distributed information or the extracted advertising information, the contents are recreated using the updated information. As a result, the latest information can be always confirmed, and the user 101 can be informed of this matter.

News has been described above as one example of the to-be-distributed information (contents), but the to-be-distributed information is not limited to the news information. The to-be-distributed information may include not only the character information, but also all kinds of contents such as image information, video information, audio information, and the one obtained by uniting these contents.

Furthermore, the method of distributing information in this embodiment may be a computer readable program that is prepared beforehand, and can be realized by executing the program by a personal computer or a computer such as workstation. This program is recorded in a computer readable recording medium such as HD (hard disk), FD (floppy disk), CD-ROM, MO and DVD, and executed by being read from the recording medium by the computer. This program may be a transmission medium that can be distributed via a network such as Internet.

As described above, with this invention, a user only selects desired to-be-distributed information from the transmitted intensive information, to automatically create a homepage comprising only desired to-be-distributed information (and advertising information), or transmit a mail containing only desired to-be-distributed information (and advertising information). Therefore, information can be arranged, by utilizing respective media characteristics, such as a mobile phone, or a personal computer, and without relying on the media. As a result, there is the effect that there can be obtained a method of distributing information, an apparatus for distributing information and an information distribution program that make it possible for users to refer to, select or obtain information efficiently, and that can act for users in arrangement of the selected information.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An apparatus for distributing information having a to-be-distributed information database which stores a plurality of to-be-distributed information, or connected to said to-be-distributed information database via a network, comprising:
an intensive information transmission unit which transmits intensive information obtained by gathering all of or a part of the to-be-distributed information stored in said to-be-distributed information database to a predetermined client unit;
a selective information receiving unit which receives selective information related to the to-be-distributed information selected from the plurality of to-be-distributed information gathered based on the intensive information;
a to-be-distributed information extraction unit which extracts only predetermined to-be-distributed information from said to-be-distributed information database, based on the selective information received by said selective information receiving unit;
a contents creation unit which creates contents, using the to-be-distributed information extracted by said to-be-distributed information extraction unit; and
a registration unit which registers the contents created by said contents creation unit in a predetermined site.

2. The apparatus for distributing information according to claim 1, further comprising:
an advertising information database which stores advertising information, or connected to the advertising information database through a network; and
an advertising information extraction unit which extracts only predetermined advertising information from said advertising information database,
wherein said contents creation unit creates the contents using the to-be-distributed information extracted by said to-be-distributed information extraction unit and the advertising information extracted by said advertising information extraction unit.

3. The apparatus for distributing information according to claim 2, further comprising:
a calculation unit which calculates the number of times the advertising information has been extracted from said advertising information database by said advertising information extraction unit, or the number of times the advertising information has been used for creating the contents by said contents creation unit; and
an accounting information preparation unit which prepares accounting information based on the number of times calculated by said calculation unit.

4. The apparatus for distributing information according to claim 1, further comprising a site information transmission unit which transmits the information related to a site registered by said registration unit to the client unit.

5. The apparatus for distributing information according to claim 1, further comprising an information update unit which updates either one information of the to-be-distributed information stored in said to-be-distributed information database and the advertising information stored in said advertising information database;
wherein when the information updated by said information update unit is the to-be-distributed information extracted by said to-be-distributed information extraction unit or the advertising information extracted by said advertising information extraction unit, said contents creation unit recreates the contents using the updated information.

6. The apparatus for distributing information according to claim 5, further comprising a recreated information transmission unit which transmits the information related to recreation to the client unit, when the contents are recreated by said contents creation unit.

7. An apparatus for distributing information having a to-be-distributed information database which stores a plurality of to-be-distributed information, or connected to said to-be-distributed information database via a network, comprising:
an intensive information transmission unit which transmits intensive information obtained by gathering all of or a part of the to-be-distributed information stored in said to-be-distributed information database to a predetermined client unit;
a first selective information receiving unit which receives first selective information related to the to-be-distributed information selected from the plurality of to-be-distributed information gathered by said intensive information transmission unit;
a to-be-distributed information extraction unit which extracts only predetermined to-be-distributed information from said to-be-distributed information database, based on the first selective information received by said first selective information receiving unit;
a to-be-distributed information transmission unit which transmits the to-be-distributed information extracted by said to-be-distributed information extraction unit to the client unit;
a second selective information receiving unit which receives second selective information related to the to-be-distributed information selected from the to-be-distributed information transmitted by said to-be-distributed information transmission unit;
a contents creation unit which creates contents, using the to-be-distributed information selected based on the second selective information received by the second selective information receiving unit; and
a registration unit which registers the contents created by said contents creation unit in a predetermined site.

8. The apparatus for distributing information according to claim 7, further comprising:
an advertising information database which stores advertising information, or connected to the advertising information database through a network; and
an advertising information extraction unit which extracts only predetermined advertising information from said advertising information database,
wherein said contents creation unit creates the contents using the to-be-distributed information extracted by said to-be-distributed information extraction unit and the advertising information extracted by said advertising information extraction unit.

9. The apparatus for distributing information according to claim 8, further comprising:
a calculation unit which calculates the number of times the advertising information has been extracted from said advertising information database by said advertising information extraction unit, or the number of times the advertising information has been used for creating the contents by said contents creation unit; and
an accounting information preparation unit which prepares accounting information based on the number of times calculated by said calculation unit.

10. The apparatus for distributing information according to claim 7, further comprising a site information transmission unit which transmits the information related to a site registered by said registration unit to the client unit.

11. The apparatus for distributing information according to claim 7, further comprising an information update unit which updates either one information of the to-be-distributed information stored in said to-be-distributed information database and the advertising information stored in said advertising information database;
wherein when the information updated by said information update unit is the to-be-distributed information extracted by said to-be-distributed information extraction unit or the advertising information extracted by said advertising information extraction unit, said contents creation unit recreates the contents using the updated information.

12. The apparatus for distributing information according to claim 11, further comprising a recreated information transmission unit which transmits the information related to recreation to the client unit, when the contents are recreated by said contents creation unit.

13. An apparatus for distributing information having a to-be-to-be-distributed information database which stores a plurality of to-be-distributed information, or connected to said to-be-distributed information database via a network, comprising:
an intensive information transmission unit which transmits intensive information obtained by gathering all of or a part of the to-be-distributed information stored in said to-be-distributed information database to a predetermined client unit;
a selective information receiving unit which receives selective information related to the to-be-distributed information selected from the plurality of to-be-distributed information gathered by said intensive information;
a to-be-distributed information extraction unit which extracts only predetermined to-be-distributed information from said to-be-distributed information database, based on the selective information received by said selective information receiving unit; and
a to-be-distributed information transmission unit which transmits the to-be-distributed information extracted by said to-be-distributed information extraction unit to the client unit.

14. A method of distributing information comprising:
an intensive information transmission step of transmitting intensive information obtained by gathering all of or a part of a plurality of to-be-distributed information to a predetermined user;
a selective information receiving step of receiving selective information related to the to-be-distributed information selected by the user from the plurality of to-be-distributed information gathered based on the intensive information;
a to-be-distributed information extraction step of extracting only predetermined to-be-distributed information, based on the selective information received in the selective information receiving step;
a contents creation step of creating contents, using the to-be-distributed information extracted in the to-be-distributed information extracting step; and
a registration step of registering the contents created in the contents creation step in a predetermined site.

15. The method of distributing information according to claim 14, further comprising:
an advertising information extraction step of extracting only predetermined advertising information based on the to-be-distributed information extracted in the to-be-distributed information extraction step;
wherein contents are created in the contents creation step, using the to-be-distributed information extracted in the to-be-distributed information extraction step and the advertising information extracted in the advertising information extraction step.

16. The method of distributing information according to claim 15, further comprising:
a display order change information receiving step of receiving display order change information that changes the display order of the contents created in the contents creation step;
wherein only predetermined advertising information is extracted in the advertising information extraction step based on the display order change information received in the display order change information receiving step.

17. The method of distributing information according to claim 15, further comprising:
a calculation step of calculating the number of times the advertising information has been extracted in the advertising information extraction step, or the number of times the advertising information has been used for creating the contents in the contents creation step; and
an accounting information preparation step of preparing accounting information based on the number of times calculated in the calculation step.

18. The method of distributing information according to claim 14, further comprising a site information transmission step of transmitting the information related to a site registered in the registration step to the user.

19. The method of distributing information according to claim 14, wherein when the information updated in the information update step is the to-be-distributed information extracted in the to-be-distributed information extraction step or the advertising information extracted in the advertising information extraction step, the contents creation step recreates the contents using the updated information.

20. The method of distributing information according to claim 19, further comprising a recreated information transmission step of transmitting the information related to recreation to the user, when the contents are recreated in the contents creation step.

21. A method of distributing information comprising:
an intensive information transmission step of transmitting intensive information obtained by gathering all of or a part of a plurality of to-be-distributed information to a predetermined user;
a first selective information receiving step of receiving selective information related to the to-be-distributed information selected by the user from the plurality of to-be-distributed information gathered based on the intensive information;
a to-be-distributed information extraction step of extracting only predetermined to-be-distributed information, based on the first selective information received in the first selective information receiving step;
a to-be-distributed information transmission step of transmitting the to-be-distributed information extracted in the to-be-distributed information extracting step to the user;
a second selective information receiving step of receiving second selective information related to the to-be-distributed information selected by the user from the to-be-distributed information transmitted in the to-be-distributed information transmission step;
a contents creation step of creating contents, using the to-be-distributed information selected by the second selective information received in the second selective information receiving step; and
a registration step of registering the contents created in the contents creation step in a predetermined site.

22. The method of distributing information according to claim 21, further comprising:
an advertising information extraction step of extracting only predetermined advertising information based on the to-be-distributed information extracted in the to-be-distributed information extraction step;
wherein contents are created in the contents creation step, using the to-be-distributed information extracted in the to-be-distributed information extraction step and the advertising information extracted in the advertising information extraction step.

23. The method of distributing information according to claim 22, further comprising:
a display order change information receiving step of receiving display order change information that changes the display order of the contents created in the contents creation step;
wherein only predetermined advertising information is extracted in the advertising information extraction step based on the display order change information received in the display order change information receiving step.

24. The method of distributing information according to claim 22, further comprising:
a calculation step of calculating the number of times the advertising information has been extracted in the advertising information extraction step, or the number of times the advertising information has been used for creating the contents in the contents creation step; and
an accounting information preparation step of preparing accounting information based on the number of times calculated in the calculation step.

25. The method of distributing information according to claim 21, further comprising a site information transmission step of transmitting the information related to a site registered in the registration step to the user.

26. The method of distributing information according to claim 21, wherein when the information updated in the information update step is the to-be-distributed information extracted in the to-be-distributed information extraction step or the advertising information extracted in the advertising information extraction step, the contents creation step recreates the contents using the updated information.

27. The method of distributing information according to claim 26, further comprising a recreated information transmission step of transmitting the information related to recreation to the user, when the contents are recreated in the contents creation step.

28. A method of distributing information comprising:
an intensive information transmission step of transmitting intensive information obtained by gathering all of or a part of a plurality of to-be-distributed information to a predetermined user;
a selective information receiving step of receiving selective information related to the to-be-distributed information selected by the user from the plurality of to-be-distributed information gathered based on the intensive information;
a to-be-distributed information extraction step of extracting only predetermined to-be-distributed information, based on the selective information received in the selective information receiving step; and
a to-be-distributed information transmission step of transmitting the to-be-distributed information extracted in the to-be-distributed information extracting step to the user.

29. A computer program containing instructions which when executed on a computer causes the computer to perform:
an intensive information transmission step of transmitting intensive information obtained by gathering all of or a part of a plurality of to-be-distributed information to a predetermined client unit;
a selective information receiving step of receiving selective information related to the to-be-distributed information selected from the plurality of to-be-distributed information gathered based on the intensive information;
a to-be-distributed information extraction step of extracting only predetermined to-be-distributed information, based on the selective information received in the selective information receiving step;
a contents creation step of creating contents, using the to-be-distributed information extracted in the to-be-distributed information extracting step; and
a registration step of registering the contents created in the contents creation step in a predetermined site.

30. The computer program according to claim 29, further making the computer execute an advertising information extraction step of extracting only predetermined advertising information, based on the to-be-distributed information extracted in the to-be-distributed information extraction step,
wherein contents are created in the contents creation step, using the to-be-distributed information extracted in the to-be-distributed information extraction step and the advertising information extracted in the advertising information extraction step.

31. The computer program according to claim 30, further making the computer execute a display order change information receiving step of receiving display order change information which changes the display order of the contents created in the contents creation step;
wherein only predetermined advertising information is extracted in the advertising information extraction step based on the display order change information received in the display order change information receiving step.

32. The computer program according to claim 30, further making the computer execute:
a calculation step of calculating the number of times the advertising information has been extracted in the advertising information extraction step, or the number of times the advertising information has been used for creating the contents in the contents creation step; and
an accounting information preparation step of preparing accounting information based on the number of times calculated in the calculation step.

33. The computer program according to claim 29, further making the computer execute a site information transmission step of transmitting the information related to a site registered in the registration step to said client unit.

34. The computer program according to claim 29, wherein when the information updated in the information update step is the to-be-distributed information extracted in the to-be-distributed information extraction step or the advertising information extracted in the advertising information extraction step, the contents creation step recreates the contents using the updated information.

35. The computer program according to claim 34, further making the computer execute a recreated information transmission step of transmitting the information related to recreation to said client unit, when the contents are recreated in the contents creation step.

36. A computer program containing instructions which when executed on a computer causes the computer to perform:
an intensive information transmission step of transmitting intensive information obtained by gathering all of or a part of a plurality of to-be-distributed information to a predetermined client unit;
a first selective information receiving step of receiving selective information related to the to-be-distributed information selected from the plurality of to-be-distributed information gathered based on the intensive information;
a to-be-distributed information extraction step of extracting only predetermined to-be-distributed information, based on the first selective information received in the first selective information receiving step;
a to-be-distributed information transmission step of transmitting the to-be-distributed information extracted in the to-be-distributed information extracting step to said client unit;
a second selective information receiving step of receiving second selective information related to the to-be-distributed information selected from the to-be-distributed information transmitted in the to-be-distributed information transmission step;
a contents creation step of creating contents, using the to-be-distributed information selected by the second selective information received in the second selective information receiving step; and
a registration step of registering the contents created in the contents creation step in a predetermined site.

37. The computer program according to claim 36, further making the computer execute an advertising information extraction step of extracting only predetermined advertising information, based on the to-be-distributed information extracted in the to-be-distributed information extraction step,
wherein contents are created in the contents creation step, using the to-be-distributed information extracted in the to-be-distributed information extraction step and the advertising information extracted in the advertising information extraction step.

38. The computer program according to claim 37, further making the computer execute a display order change information receiving step of receiving display order change information which changes the display order of the contents created in the contents creation step;
wherein only predetermined advertising information is extracted in the advertising information extraction step based on the display order change information received in the display order change information receiving step.

39. The computer program according to claim 37, further making the computer execute:
a calculation step of calculating the number of times the advertising information has been extracted in the advertising information extraction step, or the number of times the advertising information has been used for creating the contents in the contents creation step; and
an accounting information preparation step of preparing accounting information based on the number of times calculated in the calculation step.

40. The computer program according to claim 36, further making the computer execute a site information transmission step of transmitting the information related to a site registered in the registration step to said client unit.

41. The computer program according to claim 36, wherein when the information updated in the information update step is the to-be-distributed information extracted in the to-be-distributed information extraction step or the advertising information extracted in the advertising information extraction step, the contents creation step recreates the contents using the updated information.

42. The computer program according to claim 41, further making the computer execute a recreated information transmission step of transmitting the information related to recreation to said client unit, when the contents are recreated in the contents creation step.

43. A computer program containing instructions which when executed on a computer causes the computer to perform:
an intensive information transmission step of transmitting intensive information obtained by gathering all of or a part of a plurality of to-be-distributed information to a predetermined client unit;
a selective information receiving step of receiving selective information related to the to-be-distributed information selected from the plurality of to-be-distributed information gathered based on the intensive information;
a to-be-distributed information extraction step of extracting only predetermined to-be-distributed information, based on the selective information received in the selective information receiving step; and
a to-be-distributed information transmission step of transmitting the to-be-distributed information extracted in the to-be-distributed information extracting step to said client unit.
